(19) United States
(12) Patent Application Publication
(10) Pub. No.: US 2013/0028616 A1
(43) Pub. Date: Jan. 31, 2013

(54) PRINTING CONTROL DEVICE, PRINTING DEVICE, PRINTING CONTROL METHOD, AND PRINTING CONTROL SYSTEM

(71) Applicants: Hisashi KUNIHIRO, Osaka-shi (JP); Yasuyuki ISHIGURO, Osaka-shi (JP); Hitoshi NAGAHAMA, Osaka-shi (JP)

(72) Inventors: Hisashi KUNIHIRO, Osaka-shi (JP); Yasuyuki ISHIGURO, Osaka-shi (JP); Hitoshi NAGAHAMA, Osaka-shi (JP)

(21) Appl. No.: 13/558,895

(22) Filed: Jul. 26, 2012

(30) Foreign Application Priority Data
Jul. 28, 2011 (JP) 2011-165926

(51) Int. Cl. G03G 15/08; G03G 15/00

(52) U.S. Cl. 399/27; 399/81

(57) ABSTRACT

A printing control device of the present invention controls a printing device equipped with a consumable supply, and includes a display control section for causing a display section to display a printing setting screen via which printing conditions corresponding to functions of the printing device are set and entered into the printing device. The printing setting screen includes an ordering screen via which an order of the consumable supply equipped for the printing device is entered, and the ordering screen includes remaining-amount-of-consumable-supply information indicative of an index of a remaining amount of the consumable supply.

This Nonprovisional application claims priority under 35 U.S.C. §119 on Patent Application No. 2011-165926 filed in Japan on Jul. 28, 2011, the entire contents of which are hereby incorporated by reference.

### TECHNICAL FIELD

The present invention relates to a printing control device, a printing device, a printing control method, and a printing control system.

### BACKGROUND ART

There has been known a conventional technique in which a user designates and orders consumable supplies via a network. For example, Patent Literature 1 describes that a print-status monitoring screen displays the amounts of remaining ink in a plurality of ink tanks by bar indicators, and when the amount of ink reaches a level at which exchange of ink tanks is recommended, the user is notified so intelligibly by icons.

The print-status monitoring screen described in Patent Literature 1 is a screen to be displayed when a printer is in a condition which a user is to be informed of, such as shortage of remaining ink and paper jam, and includes a WEB support button. The WEB support button displayed by the print-status monitoring screen is a button by which a support service such as purchase of ink is used via the Internet. When the user presses the WEB support button to display a screen and presses a button in the screen in accordance with guidance on the screen, the user can purchase ink.

However, the technique of Patent Literature 1 has a problem as follows. In the technique, the user purchases ink in accordance with guidance on the screen provided by a WEB site. Accordingly, the displayed screen for ordering may be changed independently of the user's intention. If the user is familiar with purchase of goods by the WEB service, the user can make full use of the WEB support. However, if the user is not familiar with purchase of goods by the WEB service, the user may be confused at the ordering screen that is changed regardless of the user's intention, and consequently cannot make full use of the WEB support.

On the other hand, there is known a technique described in Patent Literature 2. At the time of printing, a superordinate device of Patent Literature 2 for controlling a printer displays, upon selection of a printer labeled “order of consumable supply” on a dropdown list showing the names of printers, a consumable supply ordering screen via which consumable supplies are ordered, and receives entry of ordered-item information for designating a consumable supply to be ordered via the consumable supply ordering screen, and transmits printing data including the received ordered-item information and an ordering process command to the printer. In accordance with the printing data, the printer having received the printing data orders, via a network, the consumable supply from a server that manages orders. In the technique of Patent Literature 2, the ordering screen is constant, so that a user who is not familiar with purchasing goods via a WEB service is not confused at the displayed ordering screen.

### CITATION LIST

### Patent Literatures

### [Patent Literature 1]

Japanese Patent Application Publication No. 2005-059303 (published on Mar. 10, 2005)

### [Patent Literature 2]

Japanese Patent Application Publication No. 2007-226506 (published on Sep. 6, 2007)

### SUMMARY OF INVENTION

### Technical Problem

However, in the technique of Patent Literature 2, a user must designate a printer labeled “order of consumable supply” on the dropdown list showing the names of printers to display the consumable supply ordering screen. A printer named “order of consumable supply” does not exist in actuality. Selection of the printer labeled “order of consumable supply” on the dropdown list is based merely on agreement for displaying the consumable supply ordering screen. Accordingly, a user must know in advance the procedure for displaying the consumable supply ordering screen for ordering consumable supplies. If the user does not know the procedure for displaying the consumable supply ordering screen for ordering consumable supplies, the consumable supply ordering screen is meaningless. Still less, a user who is not familiar with use of a printer and an information processing device which is a superordinate device of the printer cannot understand how to display the consumable supply ordering screen for ordering consumable supplies, so that it is difficult for the user to purchase consumable supplies.

The present invention was made in view of the foregoing problems. An object of the present invention is to provide a printing control device, a printing control method, and a printing control system each of which allows a user who is not familiar with use of printers and information processing devices to easily purchase consumable supplies without confusion.

### Solution to Problem

In order to solve the foregoing problems, a printing control device of the present invention is a printing control device for controlling a printing device equipped with a consumable supply, the printing control device including a display control section for causing a display section to display a printing setting screen via which printing conditions corresponding to functions of the printing device are set and entered into the printing device, the printing setting screen including an ordering screen via which an order of the consumable supply equipped for the printing device is entered, the ordering screen including remaining-amount-of-consumable-supply information indicative of an index of a remaining amount of the consumable supply.

With the arrangement, the display control section causes the display section to display the printing setting screen via which printing conditions corresponding to functions of the printing device are set and entered into the printing device, and the printing setting screen includes the ordering screen via which an order of the consumable supply equipped for the printing device is entered. Accordingly, a user can purchase a toner cartridge via the ordering screen similarly with the way of setting and entering printing conditions, without being required to carry out a special operation such as selection of a printer labeled “order of consumable supply” in a dropdown list.

Furthermore, since the ordering screen is included in the printing setting screen, the ordering screen is constant without being changed independently of the user's intention like an ordering screen provided by a WEB site. Accordingly, a user who is not familiar with purchase of goods via a WEB service can easily order a desired consumable supply without being confused at entering instructions in the screen.

Furthermore, since the ordering screen includes remaining-amount-of-consumable-supply information indicative of the index of the remaining amount of the consumable supply, a user can recognize the remaining amount of the consumable supply via the ordering screen, and when there is a consumable supply whose remaining amount is in a near shortage state, the user can order and purchase a consumable supply for replacement without confusion.

As described above, the present invention enables a user who is not familiar with use of printers and information processing devices to easily purchase a consumable supply without confusion.

In order to solve the foregoing problems, a printing device of the present invention is a printing device which is controlled by a printing control device and for which a toner cartridge or an ink cartridge is equipped as a consumable supply, including: a remaining-amount-of-consumable-supply estimation section for estimating a remaining amount of the consumable supply equipped for the printing device; a determination section for comparing the remaining amount of the consumable supply estimated by the remaining-amount-of-consumable-supply estimation section with a threshold and when the remaining amount is less than the threshold, determining that the remaining amount is in a near-shortage state; and a remaining-amount-of-consumable-supply information transmission section for transmitting remaining-amount-of-consumable-supply information including a result of determination by the determination section to the printing control device.

With the arrangement, the remaining-amount-of-consumable-supply estimation section estimates the remaining amount of the consumable supply equipped for the printing device, the determination section compares the estimated remaining amount of the consumable supply with a threshold and when the remaining amount is less than the threshold, determines that the remaining amount is in a near-shortage state, and the remaining-amount-of-consumable-supply information transmission section transmits remaining-amount-of-consumable-supply information including a result of determination by the determination section to the printing control device. Therefore, the printing device of the present invention can operate in combination with the printing control device of the present invention.

In order to solve the foregoing problems, a printing control system of the present invention is a printing control system, including: a printing device equipped with a consumable supply; and a printing control device for controlling the printing device, the printing device including: a remaining-amount-of-consumable-supply estimation section for estimating a remaining amount of the consumable supply equipped for the printing device; a determination section for comparing the remaining amount of the consumable supply estimated by the remaining-amount-of-consumable-supply estimation section with a threshold and when the remaining amount is less than the threshold, determining that the remaining amount is in a near-shortage state; and a remaining-amount-of-consumable-supply information transmission section for transmitting remaining-amount-of-consumable-supply information including a result of determination by the determination section to the printing control device, and the printing control device including a display control section for causing a display section to display a printing setting screen via which printing conditions corresponding to functions of the printing device are set and entered into the printing device, the printing setting screen including an ordering screen via which an order of the consumable supply is entered, the ordering screen including the remaining-amount-of-consumable-supply information transmitted from the printing device.

With the arrangement, it is possible to provide a printing control system that enables a user who is not familiar with use of printers and information processing devices to easily purchase a consumable supply without confusion, as already explained with respect to the printing control device of the present invention.

In order to solve the foregoing problems, a printing control method of the present invention is a printing control method, carried out by a printing control device for controlling a printing device equipped with a consumable supply, the printing control method including the step of causing a display section of the printing control device to display a printing setting screen via which printing conditions corresponding to functions of the printing device are set and entered into the printing device, the printing setting screen including an ordering screen via which an order of the consumable supply equipped for the printing device is entered, the ordering screen including remaining-amount-of-consumable-supply information indicative of an index of a remaining amount of the consumable supply.

With the arrangement, it is possible to provide a printing control method that enables a user who is not familiar with use of printers and information processing devices to easily purchase a consumable supply without confusion, as already explained with respect to the printing control device of the present invention.

The printing control device of the present invention and the printing device of the present invention may be realized by a computer. In this case, the scope of the present invention also encompasses a program for causing a computer to function as the aforementioned sections to realize the printing control device and the printing device by the computer, and a computer-readable storage medium in which the program is stored.

### Advantageous Effects of Invention

The present invention enables a user who is not familiar with use of printers and information processing devices to easily purchase a consumable supply without confusion.

### BRIEF DESCRIPTION OF DRAWINGS

FIG. 1 is a drawing showing an example of an outline of a consumable supply ordering system as a whole in accordance with the present embodiment.

FIG. 2 is a vertical cross sectional view showing an example of a schematic structure of an MFP.

FIG. 3 is a cross sectional view of a developing device.

FIG. 4 is a drawing showing an example of a toner cartridge.

FIG. 5 is a drawing showing an example of a package of a toner cartridge.

FIG. 6 is a block diagram showing a hardware configuration of an MFP.

FIG. 7 is a functional block diagram showing an example of functions of a control section of an MFP in accordance with First Embodiment, together with data stored in a storage section.

FIG. 8 is a block diagram showing an example of a hardware configuration of a PC.

FIG. 9 is a functional block diagram showing an example of functions of a control section included in a PC.

FIG. 10 is a drawing showing an example of a printing initial screen together with a first window.

FIG. 11 is a first drawing showing an example of a printing setting screen together with a second window displayed by a display.

FIG. 12 is a second drawing showing an example of the printing setting screen together with the second window displayed by a display.

FIG. 13 is a drawing showing an example of an ordering confirmation screen displayed in the second window.

FIG. 14 is a drawing showing an example of an ordering completion screen displayed in the second window.

FIG. 15 is a flowchart showing an example of a flow of an amount-of-remaining-toner information generation/transmission process.

FIG. 16 is a flowchart showing an example of a flow of an ordering notification process.

FIG. 17 is a flowchart showing an example of a consumable-supply-to-be-purchased designating process.

FIG. 18 is a flowchart showing an example of a flow of a printing request process.

FIG. 19 is a functional block diagram showing an example of functions of a control section included in an MFP in accordance with Second Embodiment, together with data to be stored in a storage section.

FIG. 20 is a drawing showing an example of a consumed-amount-of-toner table.

FIG. 21 is a drawing showing an example of a cartridge screen in accordance with Second Embodiment together with the second window.

FIG. 22 is a flowchart showing an example of an amount-of-remaining-toner information generation/transmission process.

FIG. 23 is a drawing showing an example of a flow of recycle of recycled consumable supplies.

### DESCRIPTION OF EMBODIMENTS

The following explains an embodiment of the present invention with reference to drawings. In the following explanations, the same members are given the same reference signs. Members given the same reference signs have the same names and the same functions. Accordingly, detailed explanations thereof are not repeated.

### First Embodiment

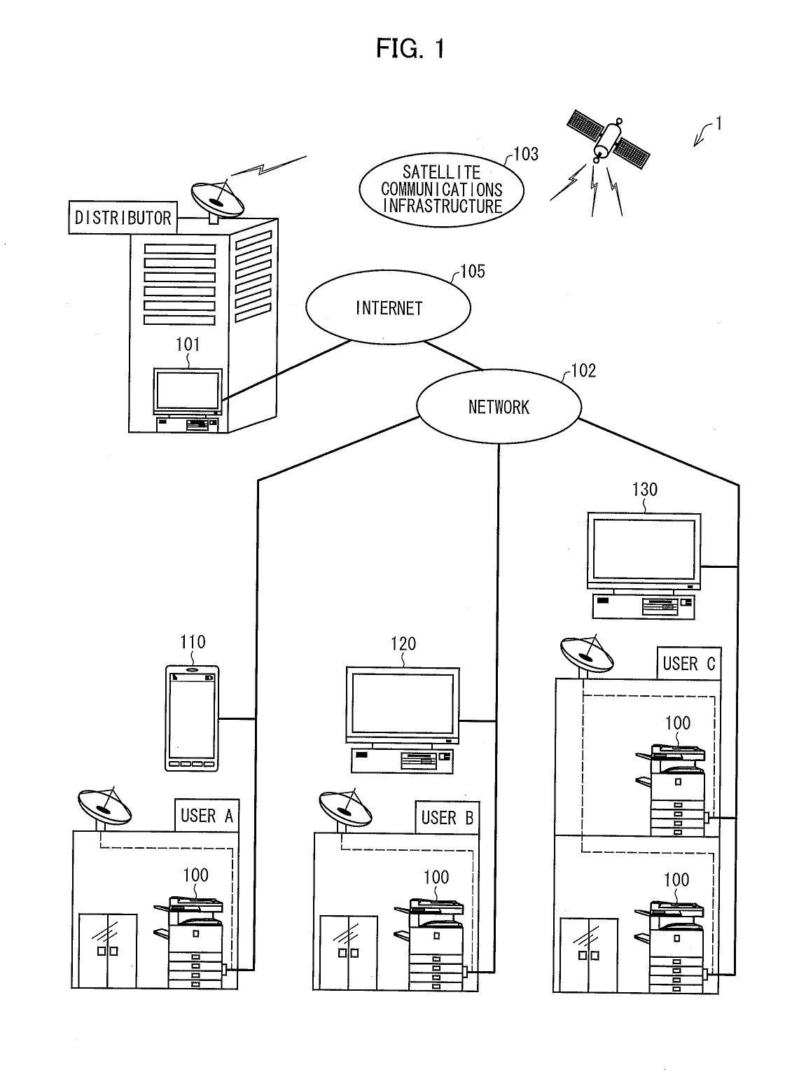

FIG. 1 is a drawing showing an example of an outline of a consumable supply ordering system as a whole in accordance with the present embodiment. As shown in FIG. 1, a consumable supply ordering system (printing control system) 1 includes a plurality of multifunction printers (hereinafter “MFP”) 100 each connected with a network 102, a server PC 101, a portable terminal (printing control device 110, and PCs (printing control device) 120 and 130. The MFP (printing device) 100 is an example of an image forming device, and has a plurality of functions such as a scanner function, a copy function, a facsimile function, and a printer function.

The plurality of MFPs 100, the portable terminal 110, the PC 120, and the PC 130 are connected with each other via the network 102 and are communicable with each other. The network 102 is a local area network (LAN) and may be in the form of wired lines or wireless communications. The network 102 is not limited to LAN, and may be a wide area network (WAN), a public switched telephone network (PSTN) etc.

The network 102 is connected with the Internet 105 via a gateway, and the plurality of MFPs 100, the portable terminal (printing control device) 110, the PCs (printing control device) 120 and 130 are communicable with the server PC 101 connected with the Internet 105. Communications may be made via a satellite communications infrastructure 103.

The server PC 101 in accordance with the present embodiment is a server provided by a distributor that sells consumable supplies for the MFP 100. Examples of the distributor include a leasing company that leases the MFP 100, a distributor that sells the MFP 100, a maker of the MFP 100, a maker of consumable supplies, and a cloud provider (provider of a cloud computing service).

The PCs 120 and 130 are general personal computers, and a driver program for controlling the MFP 100 is installed to the PCs 120 and 130. Accordingly, the PCs 120 and 130 can transmit printing data to the MFP 100 so as to form images indicated by the printing data.

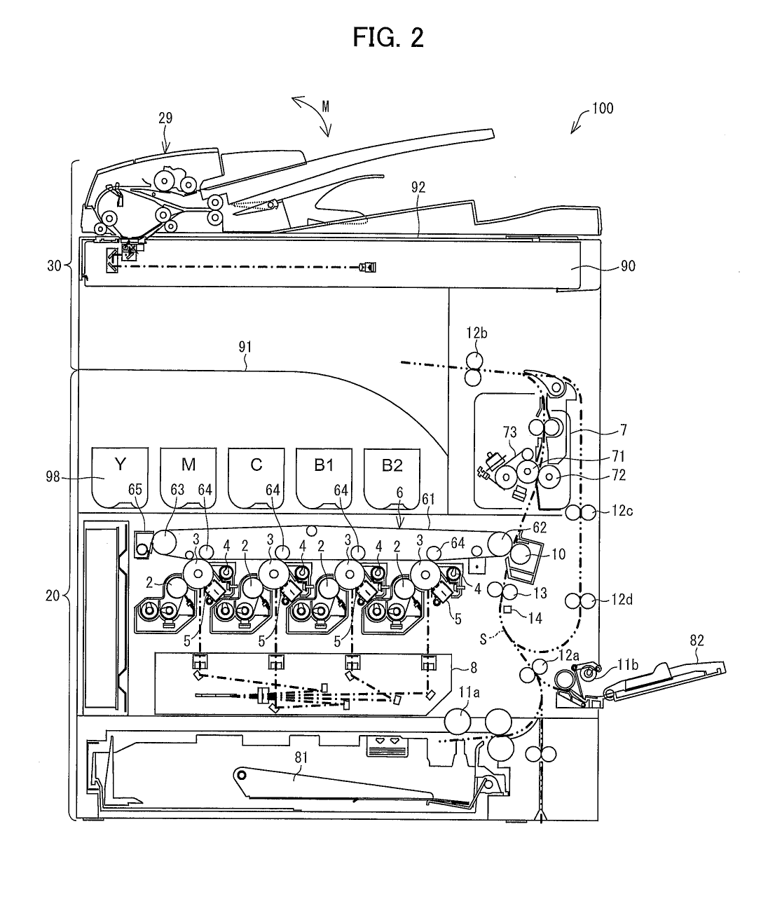

FIG. 2 is a vertical cross sectional view showing an example of a schematic structure of an MFP. As shown in FIG. 2, the MFP 100 includes an image forming unit 20 and a document reading unit 30. The image forming unit 20 can include four image forming stations P1-P4. The four image forming stations P1-P4 each include a developing device 2, a photoconductor drum 3, a charger 5, and a cleaner unit 4, and three of P1-P4 each include a toner cartridge 98, and remaining one of P1-P4 includes two toner cartridges 98, and have basically the same structure. It should be noted that each image forming station P has unique identification information, and a later-mentioned control section 201 can identify each image forming station P. Since the MFP 100 includes four image forming stations P, the MFP 100 can form an image by using four toners (developers). The four toners are black (B1, B2), cyan (C), magenta (M), and yellow (Y), and are contained in five toner cartridges 98 respectively. When the toner cartridge 98 containing B1 runs out of toner, the toner cartridge 98 containing B1 is automatically replaced with the toner cartridge 98 containing B2.

The charger 5 is charging means for evenly charging a surface of the photoconductor drum 3 with a predetermined potential. Examples of the charger 5 include noncontact chargers and contact chargers such as a roller charger and a brush charger.

An exposure unit 8 exposes the surface of the charged photoconductor drum 3 in accordance with input image data to form an electrostatic latent image corresponding to the image data.

The developing device 2 visualizes the electrostatic latent image formed on the photoconductor drum 3 by toner to develop the image. Electrostatic latent images on the respective photoconductor drums 3 are formed for respective color components indicated by image data, and are developed by the developing devices 2, respectively.

The cleaner unit 4 removes and collects the toner remaining on the surface of the photoconductor drum 3 after the development and the image transfer.

An intermediate transfer belt unit 6 positioned above the photoconductor drums 3 includes an intermediate transfer belt 61, an intermediate transfer belt driving roller 62, an intermediate transfer belt driven roller 63, intermediate transfer rollers 64, and an intermediate transfer belt cleaning unit 65. The intermediate transfer rollers 64 are provided in the number of four so as to correspond to the four image forming stations P1-P4, respectively.

The intermediate transfer belt driving roller 62, the intermediate transfer belt driven roller 63, and the intermediate transfer rollers 64 support the intermediate transfer belt 61 in a tensioned state so as to rotate the intermediate transfer belt 61. Furthermore, each of the intermediate transfer rollers 64 applies a transfer bias for transferring the toner image on the corresponding photoconductor drum 3 onto the intermediate transfer belt 61.

The intermediate transfer belt 61 is provided in such a manner as to touch each of the photoconductor drums 3. Toner images with respective colors on the photoconductor drums 3 are sequentially superimposed and transferred onto the intermediate transfer belt 61, so that a multicolored toner image is formed on the intermediate transfer belt 61.

The multicolored toner image formed on the intermediate transfer belt 61 by superimposing the toner images with respective colors is transferred onto a sheet by a transfer roller 10 positioned at a later-mentioned place where the intermediate transfer belt 61 contacts a sheet as a result of rotation of the intermediate transfer belt 61.

A registration roller 13 temporarily holds a sheet conveyed through a sheet conveying path S. The registration roller 13 conveys a sheet to the transfer roller 10 with timing when the top end of the toner image on the photoconductor drum 3 contacts the top end of the sheet.

At the downstream of conveyance of a sheet from the registration roller 13, a sheet detection sensor 14 is positioned closely to the registration roller 13. The sheet detection sensor 14 detects a sheet that passes through the registration roller 13, and is a registration sensor constituted by a photointerruptor for example.

A fixing unit 7 includes a heat roller 71 and a pressure roller 72. The fixing unit 7 thermally presses toner onto a sheet by the pressure roller 72, so that the multicolored toner image having been transferred onto the sheet is melted, mixed, and pressed and thus thermally fixed onto the sheet. Furthermore, an external heating belt 73 for externally heating the heat roller 71 is provided.

The document reading unit 30 mainly has an automatic document feeding device 29 and a scanning section 90. A plurality of document sheets placed on the mounting tray of the automatic document feeding device 29 are successively fed to an upper part of the scanning section 90, so that the document is read.

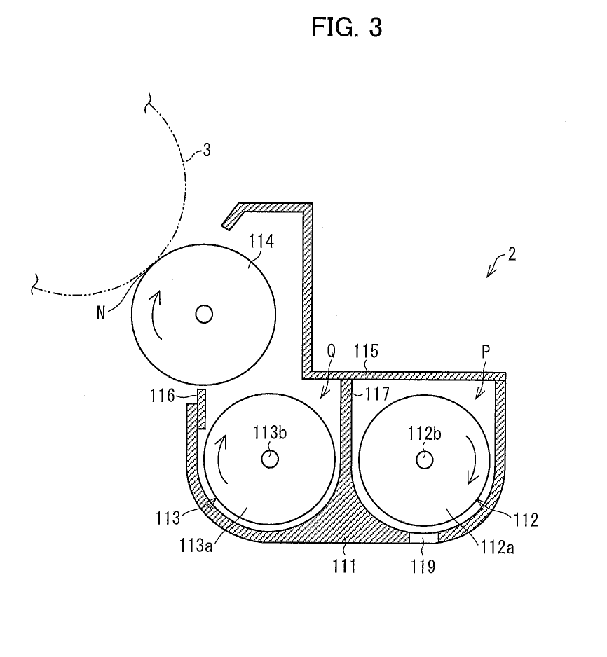

FIG. 3 is a cross sectional view of the developing device 2. The developing device 2 includes, inside a developing tank 111, a developing roller 114 positioned in such a manner as to face the photoconductor drum 3. The developing device 2 supplies toner to the surface of the photoconductor drum 3 by the developing roller 114, thereby visualizing (developing) the electrostatic latent image on the surface of the photoconductor drum 3.

The developing device 2 includes, in addition to the developing roller 114, the developing tank 111, a developing tank cover 115, a doctor blade 116, a first conveyance member 112, a second conveyance member 113, a partition plate 117, and a toner density sensor 119.

The developing tank 111 contains two-component developer containing toner and carrier (hereinafter merely referred to as “developer”). The developing tank 111 includes the developing roller 114, the first conveyance member 112, the second conveyance member 113 etc. The carrier used in the present embodiment is magnetic carrier.

The developing tank cover 115 which is removable is placed on the top of the developing tank 111. The developing tank cover 115 has a toner supply opening (not shown) for supplying unused toner into the developing tank 111.

In the developing tank 111, the partition plate 117 is placed between the first conveyance member 112 and the second conveyance member 113. The partition plate 117 extends in parallel with axis directions of the first conveyance member 112 and the second conveyance member 113. The inside of the developing tank 111 is partitioned by the partition plate 117 into a first conveyance path P where the first conveyance member 112 is positioned and a second conveyance path Q where the second conveyance member 113 is positioned.

The partition plate 117 is designed to be apart from the inside wall surface of the developing tank 111 at both ends in axis directions of the first conveyance member 112 and the second conveyance member 113. Consequently, the developing tank 111 has communication paths between the first conveyance path P and the second conveyance path Q in the vicinity of both ends in axis directions of the first conveyance member 112 and the second conveyance member 113.

The first conveyance member 112 and the second conveyance member 113 are aligned in such a manner that circumferential surfaces thereof face each other via the partition plate 117 and axes thereof are parallel to each other. The first conveyance member 112 and the second conveyance member 113 rotate in opposite directions. The first conveyance member 112 and the second conveyance member 113 convey a developer in opposite directions.

The first conveyance member 112 includes: a screw auger consisting of a first conveyance blade 112a having a spiral shape and a first rotation axis 112b; and a gear. The second conveyance member 113 includes: a screw auger consisting of a second conveyance blade 113a having a spiral shape and a second rotation axis 113b; and a gear. The first conveyance member 112 and the second conveyance member 113 stir and convey the developer by being rotated by driving means (not shown) such as a motor.

The developing roller 114 is a magnet roller that is rotated around an axis by driving means (not shown). The developing roller 114 draws up the developer in the developing tank 111 and holds the developer on the surface of the developing roller 114, and supplies toner contained in the developer held on the surface to the photoconductor drum 3.

The developer conveyed by the developing roller 114 contacts the photoconductor drum 3 at a portion where the developing roller 114 is closest to the photoconductor drum 3. The area where the developer contacts the photoconductor drum 3 is referred to as a developing nip section N. At the developing nip section N, a developing bias voltage is applied to the developing roller 114 from a power source (not shown) connected with the developing roller 114, and toner is supplied to the electrostatic latent image on the surface of the photoconductor drum 3 from the developer on the surface of the developing roller 114. The doctor blade 116 is positioned closely to the surface of the developing roller 114.

The doctor blade 116 is a plate-like member that extends in parallel with an axis direction of the developing roller 114. The doctor blade 116 is positioned in such a manner that one end of the doctor blade 116 in a short side direction thereof is supported by the developing tank 111 below the developing roller 114 in a normal direction of the developing roller 114, and the other end of the doctor blade 116 elongates along the surface of the developing roller 114 with a gap therebetween. Examples of the material of the doctor blade 116 include stainless steel, aluminum, and synthetic resin.

The toner density sensor 119 is mounted on the bottom surface of the developing tank 111 below the first conveyance member 112 in a normal direction thereof, that is, on the bottom surface of the first conveyance path P. The toner density sensor 119 is positioned in such a manner that a sensor surface thereof is exposed to the inside of the developing tank 111.

The toner density sensor 119 is a magnetic permeability sensor for example, and senses magnetic permeability of irons contained in carrier per unit volume in the vicinity of the bottom surface of the developing device 2. As the magnetic permeability is larger, the toner density is smaller. The toner density sensor 119 outputs the sensed magnetic permeability to the control section 201.

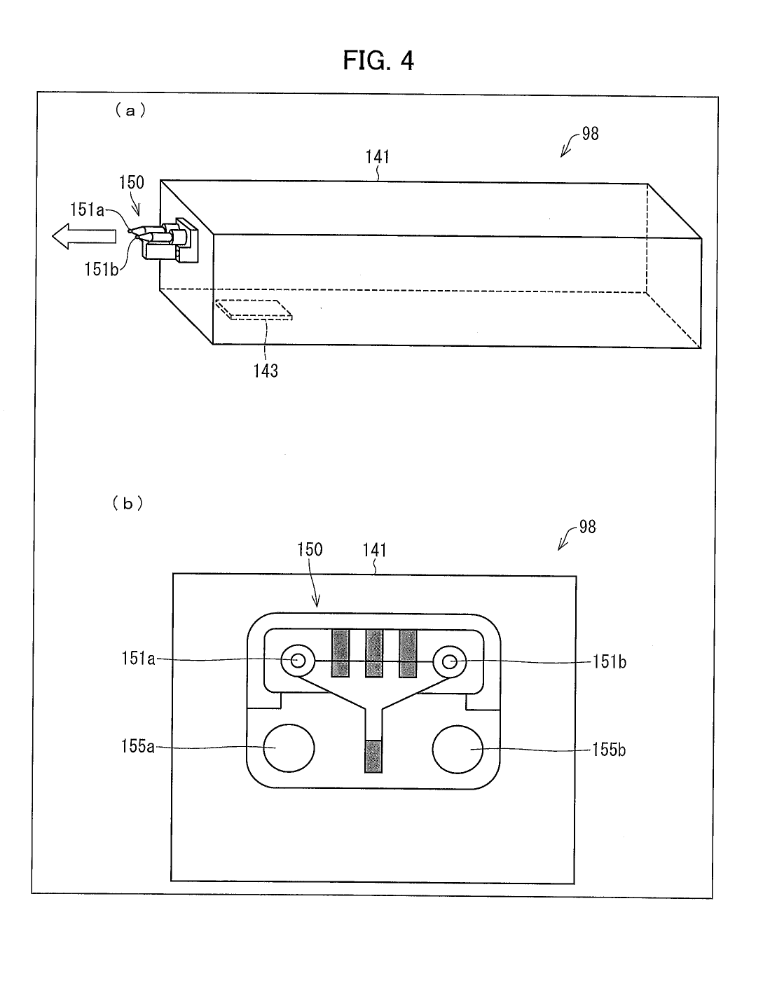

FIG. 4 is a drawing showing an example of a toner cartridge. (a) of FIG. 4 is a perspective view schematically showing the toner cartridge. (b) of FIG. 4 is an elevation view showing the toner cartridge. As shown in (a) and (b) of FIG. 4, the toner cartridge 98 includes a toner cartridge main body 141 and a storage section 150 provided at the front side of the toner cartridge main body 141. The toner cartridge main body 141 contains one of four kinds of toner, and the contained toner is supplied to the corresponding developing device 2 via a supply opening 143.

The storage section 150 includes screws 155a and 155b, a terminal 153, and positioning bosses 151a and 151b. The storage section 150 is fixed by the screws 155a and 155b to a fixing position of the toner cartridge main body 141. The storage section 150 is fixed by the positioning bosses 151a and 151b to a fixing position of the image forming unit 20 where the toner cartridge 98 is to be fixed. Consequently, the terminal 153 of the storage section 150 and a terminal of the MFP 100 contacts with each other, so that the storage section 150 and the MFP 100 are electrically connected with each other. Thus, the MFP 100 can communicate with the storage section 150, and extracts information from the storage section 150.

The storage section 150 used here is a contact type nonvolatile memory, but not limited to this. The storage section 150 may be a noncontact one using wireless communications, such as an IC chip, a barcode, and a QR Code®.

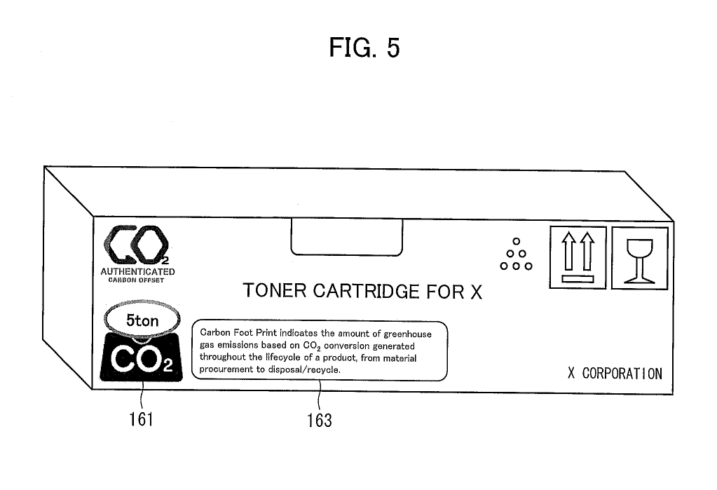

The toner cartridge 98 may have thereon a Carbon Footprint Mark® which indicates greenhouse gases based on CO₂ conversion emitted throughout the lifecycle of a product and a service (from material procurement to disposal/recycle). FIG. 5 shows an example of a carbon footprint mark 161 attached to a package of the toner cartridge 98. This can easily let an environment-conscious user see that the maker of the toner cartridge 98 makes positive efforts to reduce greenhouse gases. The carbon footprint mark 161 may be labeled on the toner cartridge 98 itself.

In addition to the carbon footprint mark 161, an explanation of the carbon footprint mark may be added. In the example shown in FIG. 5, an explanation is provided at a region 163 of the package of the toner cartridge 98. This can easily let a particularly environment-conscious user see that the maker of the toner cartridge 98 makes positive efforts to reduce greenhouse gases, thereby easing the user's mind. Furthermore, this can let an environment-unconscious user realize the importance of reducing greenhouse gases and urge the user to reduce greenhouse gases, thereby contributing to prevention of global warning. The greenhouse gases include six gases that are targeted in the Kyoto Protocol: CO₂, CH₄, N₂O, HFCₛ, PFCₛ, and SF₆.

The amount of CO₂ emissions is calculated by a general expression below using LCA (lifecycle assessment) method. General expression: the amount of CO₂ emission=Σ(activity amount i×basic unit of CO₂ emission)

i indicates the activity amount (process) from material procurement to disposal/recycle. The unit of CO₂ emission is represented by units indicative of weights, such as (kg), (g), and (t). Individual stages of the lifecycle correspond to the activity amounts as shown in (1)-(5) below.

(1) Activity amount at the stage of material procurement is the amount of a used raw material.
(2) Activity amount at the stage of production is the fabrication weight and the amount of power consumed in production.
(3) Activity amount at the stage of distribution is traffic volume (product of haul distance, loading ratio, and load capacity of truck)
(4) Activity amount at the stage of use/maintenance is the amount of power consumption in use.
(5) Activity amount at the stage of disposal/recycle is the landfill weight and the recycled weight.

In the example shown in FIG. 5, the sum of (1)-(5) is 5.0 ton-CO₂.

In the present embodiment, the distributor at which the server PC 101 is provided manages plural kinds of toner cartridges. The server PC 101 receives an order of a toner cartridge out of the plural kinds of toner cartridges by a user via the PC 120 or 130, and the distributor ships the toner cartridge the order of which has been received by the server PC 101 to the user of the PC 120 or 130. Consequently, the user can replace the toner cartridge 98 used with an unused toner cartridge shipped to the user.

The server PC 101 manages five kinds of toner cartridges (B1, B2, C, M, Y) suitable for the MFP 100, and three kinds of cartridge containers are used for each of the five kinds of toner cartridges. The three kinds of cartridge containers include a non-recycled cartridge container, a first recycled cartridge container (recycled consumable supply B), and a second recycled cartridge container (recycled consumable supply A). The non-recycled cartridge container is one in which no members constituting the container are recycled members. The first recycled cartridge container is recycled one consisting of recycled members obtained by cleaning members constituting the original container and replacing a part of the members etc. Accordingly, the first recycled cartridge container is higher in the ratio of recycled members than the non-recycled cartridge container, and therefore can reduce the amount of greenhouse gas emission in production of the cartridge container, compared with the non-recycled cartridge container. The second recycled cartridge container is one consisting of recycled members obtained by processing used members into new raw materials and then molding the new raw materials. Accordingly, the second recycled cartridge container requires a more amount of power consumption in production than the first recycled cartridge container, and therefore the amount of greenhouse gas emission in production of the second recycled cartridge container is larger than that of the first recycled cartridge container, although smaller than that of the non-recycled cartridge container. Ratios of reduction in greenhouse gas emission of the first recycled cartridge container and the second recycled cartridge container to the non-recycled cartridge container are 15% and 5% respectively for example.

The greenhouse gases include six gases that are targeted in the Kyoto Protocol, i.e. CO₂, CH₄, N₂O, HFCₛ, PFCₛ, and SF₆. The amount of greenhouse gas emission here is based on CO₂ conversion.

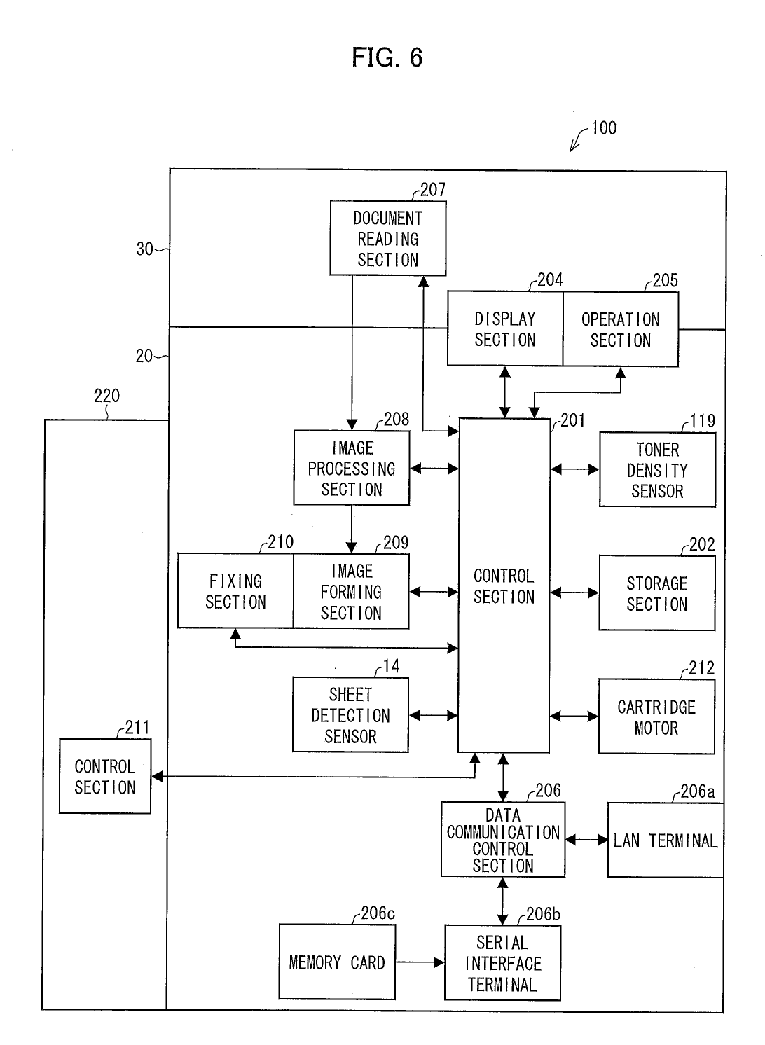

FIG. 6 is a block diagram showing a hardware configuration of an MFP. As shown in FIG. 6, the MFP 100 includes a control section 201, a storage section 202 in which a program to be executed by the control section 201 etc. is stored, and a control section 211 for controlling a peripheral device 220.

The control section 201 is connected with each of a display section 204, an operation section 205, a data communication control section 206, a document reading section 207, an image processing section 208, an image forming section 209, a fixing section 210, the toner density sensor 119, a cartridge motor 212, and the sheet detection sensor 14, and controls the MFP 100 as a whole.

The data communication control section 206 includes an LAN terminal 206a serving as an interface for communications based on a communication protocol and a serial interface terminal 206b for serial communications. In accordance with instructions from the control section 201, the data communication control section 206 transmits/receives data to/from an external device connected with the LAN terminal 206a or the serial interface terminal 206b.

In a case where the LAN terminal 206a is connected with a cable for connection with the Internet 105, the data communication control section 206 communicates with the server PC 101 connected with the data communication control section 206 via the LAN terminal 206a.

The serial interface terminal 206b is connectable with a memory card 206c including a flash memory. The control section 201 can update a program to be executed by the control section 201 by controlling the data communication control section 206 to read out the program from the memory card 206c and causing the program to be stored in the storage section 202.

The storage medium in which the program to be executed by the control section 201 is stored is not limited to a memory card, and may be mediums such as a flexible disc, an optical disc, an IC card, an optical card, and semiconductor memories (e.g. mask ROM, EEPROM).

The document reading section 207 includes a light source for radiating light to a document conveyed to a document reading position and a photoelectric conversion element for receiving light reflected by the document, and scans a document image corresponding to the size of the document. The photoelectric conversion element converts the received light into image data which is an electric signal, and outputs the image data to the image processing section 208.

The image processing section 208 subjects the image data from the document reading section 207 to various data processes such as shading correction, and then outputs the resulting data to the image forming section 209. A sheet feeding section (not shown) conveys a sheet stored in a sheet feeding cassette 81 and a manual sheet feeding cassette 82 to the image forming section 209.

The image forming section 209 forms an image on the sheet conveyed by the sheet feeding section (not shown) in accordance with the image data having been subjected to the data processes. Then, the image forming section 209 ejects the sheet on which the image has been formed onto a sheet output tray 91.

The fixing section 210 (corresponding to the fixing unit 7) melts the toner image having been formed on the sheet by the image forming section 209, thereby fixing the image on the sheet.

The sheet detection sensor 14 is put in an on-state when a sheet exists at a position where the sheet detection sensor 14 is provided, and is put in an off-state when a sheet does not exist at the position where the sheet detection sensor 14 is provided. In the present embodiment, the sheet detection sensor 14 is provided in the vicinity of the registration roller 13, and the number and the size of sheets having passed through the registration roller 13 can be detected in accordance with on/off of a signal from the sheet detection sensor 14. The signal from the sheet detection sensor 14 is inputted to the control section 201.

The control section 201 controls density of toner in the developing device 2. Every time printing is carried out, the toner in the developing device 2 is consumed, so that the density of the toner drops. The control section 201 appropriately supplies toner contained in the toner cartridge 98 to the developing device 2 so that the density of the toner in the developing device 2 is within a predetermined density range.

The cartridge motor 212 rotates a supply roller (not shown) provided in the vicinity of a toner supply opening (not shown) of the toner cartridge 98, thereby supplying toner contained in the toner cartridge 98 to the developing device 2. As the toner in the developing device 2 is consumed by printing and gets smaller in amount, the output from the toner density sensor 119 gets higher. When the output from the toner density sensor 119 is higher than a first predetermined value (density of the toner in the developing device 2 is smaller than a predetermined value), the cartridge motor 212 is driven to rotate until the output from the toner density sensor 119 reaches a second predetermined value lower than the first predetermined value, so that toner is supplied into the developing device 2. The amount of supplied toner is proportional to the time for driving the cartridge motor 212, the amount of toner supplied from the toner cartridge 98 can be estimated based on the time for driving the cartridge motor 212.

The display section 204 is a display device such as a liquid crystal display (LCD), an organic ELD (Electro Luminescence Display), a display using electrophoresis (e.g. electronic paper), a plasma display (PDP), a plasma tube array display (PTAD), and a display using electron-releasing elements (FED, SED). The display section 204 displays a screen including an instruction menu (e.g. setting screen for a user) and information on acquired image data.

The operation section 205 has a plurality of keys, and receives instructions made by user's operations corresponding to the keys, and data such as characters and numerals. The plurality of keys of the operation section 205 are hardware keys including a switch. The operation section 205 may include a touch panel as a part of the keys, or may be a touch panel itself. In a case where the operation section 205 includes a touch panel or in a case where the operation section 205 is a touch panel itself, the touch panel is provided on the display section 204. A gesture input using a wearable interface of a finger-wearing type may be employed.

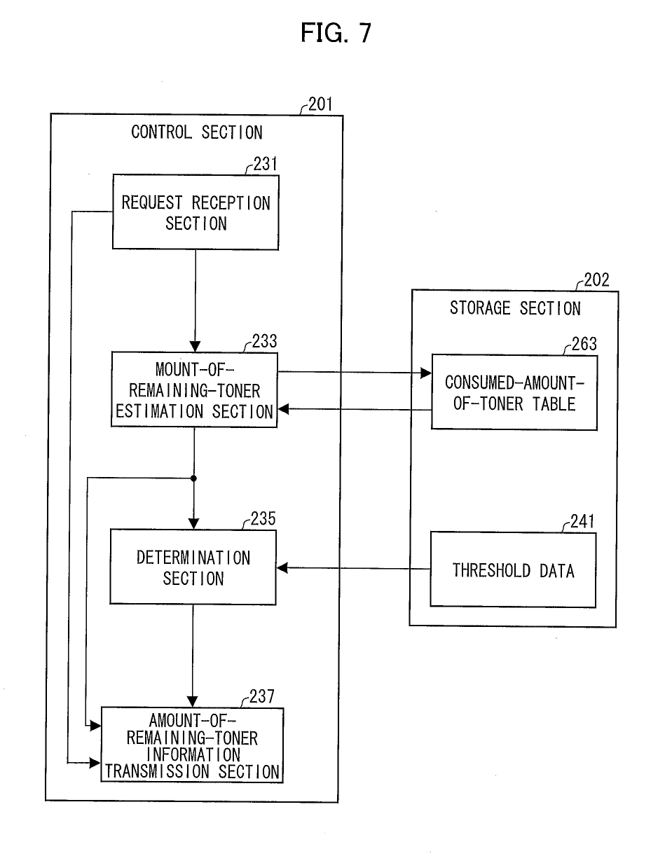

FIG. 7 is a block diagram showing an example of functions of the control section of the MFP together with data stored in the storage section. As shown in FIG. 7, the control section 201 includes a request reception section 231, an amount-of-remaining-toner estimation section (remaining-amount-of-consumable-supply estimation section, consumed-amount-of-coloring-material calculation section) 233, a determination section 235, and an amount-of-remaining-toner information transmission section (remaining-amount-of-consumable-supply information transmission section) 237.

Threshold data 241 is stored in the storage section 202. The threshold data 241 is a value for determining whether the amount of remaining toner in the toner cartridge 98 is in a near-shortage state. Here, the threshold data 241 is set to a value corresponding to 20% of the maximum amount of toner containable in the toner cartridge 98.

The request reception section 231 receives a request from one of the PCs 120 and 130 to transmit the amount of remaining toner. Upon reception of the request to transmit the amount of remaining toner, the request reception section 231 outputs an estimation instruction to the amount-of-remaining-toner estimation section 233, and outputs, to the amount-of-remaining-toner information transmission section 237, a transmission instruction including device identification information on the PC having requested to transmit the amount of remaining toner.

The amount-of-remaining-toner estimation section 233 estimates the amount of remaining toner in the toner cartridge 98. Upon reception of the estimation instruction from the request reception section 231, the amount-of-remaining-toner estimation section 233 generates, with respect to each of the five toner cartridges 98, amount-of-remaining-toner data including the estimated amount of remaining toner and toner cartridge identification information for identifying the toner cartridge 98, and outputs the generated amount-of-remaining-toner data to the determination section 235 and the amount-of-remaining-toner information transmission section 237. Furthermore, the amount-of-remaining-toner estimation section 233 estimates the amount of remaining toner in the toner cartridge 98 also at predetermined timings such as when the power source of the MFP 100 is made on and when a process control is carried out, regardless of the estimation instruction from the request reception section 231.

The amount of remaining toner is calculated by subtracting the accumulative amount of consumed toner from the maximum amount of toner containable in the toner cartridge 98. The accumulative amount of consumed toner may be calculated in such a manner that the amounts of consumed toner have been stored from when the toner cartridges 98 were exchanged, and the stored amounts of consumed toner up to the present are accumulated.

Specifically, the accumulative amount of consumed toner is calculated based on a consumed-amount-of-toner table (consumed-amount-of-coloring-material table) 263 stored in the storage section 202.

The amount-of-remaining-toner estimation section 233 monitors consumption of toner in printing, and calculates the amount of consumed toner with respect to each of the five toner cartridges 98. Then, the amount-of-remaining-toner estimation section 233 generates consumed-amount-of-toner data including the calculated amount of consumed toner and toner cartridge identification information with respect to each of the five toner cartridges 98, and causes the consumed-amount-of-toner data to be added to the consumed-amount-of-toner table 263 in the storage section 202 and stored therein. In the consumed-amount-of-toner table 263, the date when the amount of consumed toner was calculated is related to the amount of consumed toner with respect to each of the five toner cartridges 98.

Examples of the method for calculating the amount of consumed toner include a first calculation method, a second calculation method, and a third calculation method below. The first calculation method calculates the amount of consumed toner based on a grayscale of each pixel of image data. As a pixel is larger and a grayscale of a pixel is higher, the amount of consumed toner is larger. Accordingly, the amount of consumed toner can be estimated based on grayscales of image data.

In the first calculation method, the remaining toner estimation section 233 counts grayscales of image data of an input multivalued image (e.g. multiple grayscale image such as 16-grayscale image and 256-grayscale image) with respect to each pixel, and weights the counted grayscales according to their levels with respect to each pixel. The counted grayscale is weighted larger as the counted grayscale is higher. This is because the amount of consumed toner is larger as the grayscale is higher. The amount-of-remaining-toner estimation section 233 specifies the weighted grayscales as pixel count values, and accumulates pixel count values for all the pixels included in the image data. Then, the amount-of-remaining-toner estimation section 233 converts the accumulated pixel count values into the amount of consumed toner.

The second calculation method calculates the amount of consumed toner based on a time for driving the cartridge motor 212. Specifically, in the second calculation method, the amount-of-remaining-toner estimation section 233 accumulates the times for driving the cartridge motor 212, and regards the amount of supplied toner corresponding to the accumulated times as the amount of consumed toner.

The third calculation method calculates the amount of consumed toner based on density of toner in the developing device 2. The density of toner in the developing device 2 is controlled by the control section 201 to be an ideal value, but when the amount of remaining toner in the toner cartridge 98 is small, toner is not supplied to the developing device 2 sufficiently. Consequently, density of toner in the developing device 2 is not kept constant, and drops gradually. Therefore, on condition that the toner cartridge 98 runs out of toner and cannot supply toner into the developing device 2, it is possible to estimate the amount of consumed toner based on density of toner in the developing device 2.

In the third calculation method, the amount-of-remaining-toner estimation section 233 calculates the amount of consumed toner by converting variation in density of toner in the developing device 2 into the amount of consumed toner. Variation in density of toner may be specified by comparing density of toner in the developing device 2 with a plurality of predetermined thresholds.

It is preferable that the amount-of-remaining-toner estimation section 233 calculates the amount of consumed toner by suitably combining the first to third calculation methods. For example, until the amount of remaining toner reaches 30% of the maximum amount of toner containable in the toner cartridge 98, the amount-of-remaining-toner estimation section 233 calculates the amount of consumed toner by the second calculation method. When the amount of remaining toner is between 10% and 30% of the maximum amount of toner containable in the toner cartridge 98, the amount-of-remaining-toner estimation section 233 calculates the amount of consumed toner by the first calculation method. When the amount of remaining toner is between 5% and 10% of the maximum amount of toner containable in the toner cartridge 98, the amount-of-remaining-toner estimation section 233 calculates the amount of consumed toner by the third calculation method.

The amount-of-remaining-toner estimation section 233 also has a function of a consumed-amount-of-toner calculation section. In a case of calculating the amount of consumed toner by the first calculation method, the amount-of-remaining-toner estimation section 233 calculates, every time when a print job is carried out, the amount of toner consumed in the print job, and causes the calculated amount together with the date to be stored in the consumed-amount-of-toner table 263.

In a case of calculating the amount of consumed toner by the second calculation method, the amount-of-remaining-toner estimation section 233 calculates, every time when the cartridge motor 212 is driven, the amount of consumed toner (amount of supplied toner) corresponding to the time for driving the cartridge motor 212, and causes the calculated amount together with the date to be stored in the consumed-amount-of-toner table 263.

In a case of calculating the amount of consumed toner by the third calculation method, the amount-of-remaining-toner estimation section 233 calculates, with respect to predetermined number of printed sheets, the amount of consumed toner based on the output from the toner density sensor 119, and causes the calculated amount together with the date to be stored in the consumed-amount-of-toner table 263.

The determination section 235 determines whether there is a toner cartridge 98 whose remaining toner is in a near-shortage state. The determination is made based on five amount-of-remaining-toner data generated by the amount-of-remaining-toner estimation section 233 and the threshold data 241 stored in the storage section 202. Specifically, the amounts of remaining toner included in respective five amount-of-remaining-toner data generated by the amount-of-remaining-toner estimation section 233 are compared with a threshold T1 indicated by the threshold data 241, and when the amount of remaining toner is less than the threshold T1, it is determined that the toner cartridge 98 specified by the amount-of-remaining-toner data of interest contains toner in a near-shortage state.

In a case where there is a toner cartridge 98 whose remaining toner is in a near-shortage state, the determination section 235 incorporates, into a first determination result indicating so, toner cartridge identification information of the toner cartridge 98 whose remaining toner is in a near-shortage state. In a case where there are a plurality of toner cartridges 98 whose remaining toner is in a near-shortage state, the determination section 235 incorporates, into a first determination result indicating so, toner cartridge identification information of the plurality of toner cartridges 98 whose remaining toner is in a near-shortage state. The determination section 235 outputs the first determination result to the amount-of-remaining-toner information transmission section 237. In a case where there is no toner cartridge 98 whose remaining toner is in a near-shortage state, the determination section 235 outputs a second determination result indicating so to the amount-of-remaining-toner information transmission section 237.

In response to the request from the PC 120 or 130, the amount-of-remaining-toner information transmission section 237 transmits amount-of-remaining-toner information (remaining-amount-of-consumable-supply information) to the PC 120 or 130 that has requested to transmit the amount of remaining toner. Specifically, upon reception of the generated five amount-of-remaining-toner data from the amount-of-remaining-toner estimation section 233, the amount-of-remaining-toner information transmission section 237 transmits amount-of-remaining-toner information including the received five amount-of-remaining-toner data and the determination result by the determination section 235 to a PC specified by device identification information included in the transmission instruction from the request reception section 231.

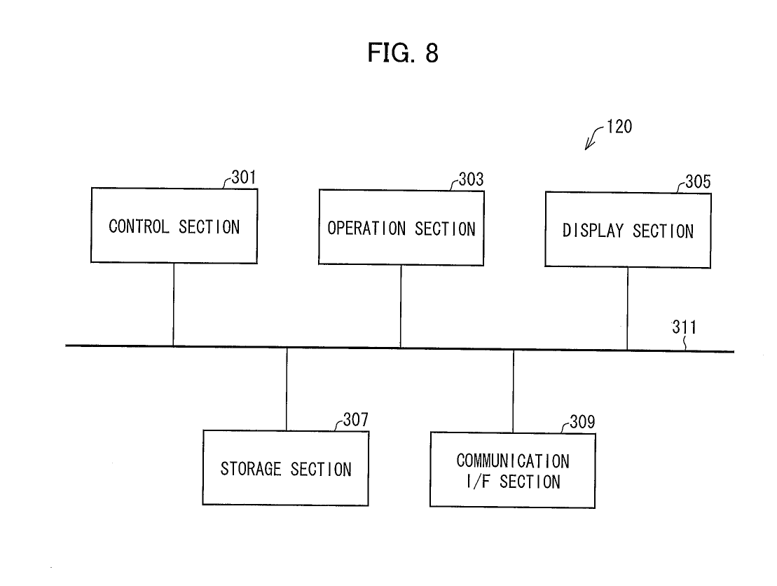

FIG. 8 is a block diagram showing an example of a hardware configuration of a PC. Since the PC 120 and the PC 130 have the same function and the same configuration, an explanation is made to the PC 120. As shown in FIG. 8, the PC 120 is configured such that a control section 301 for controlling the whole of the PC 120, a storage section 307 in which a program etc. executed by the control section 301 is stored, an operation section 303 via which user's operation is entered, a display section 305, and a communication I/F section 309 are connected with a bus 311.

The communication I/F section 309 is an interface for connecting the PC 120 with the network 102. The control section 301 communicates, via the communication I/F section 309, with the plurality of MFPs 100, the mobile terminal 110 or the PC 130, and transmits/receives data to/from them. Furthermore, the communication I/F section 309 can communicate, via the network 102, with a computer (e.g. server PC 101) connected with the Internet 105.

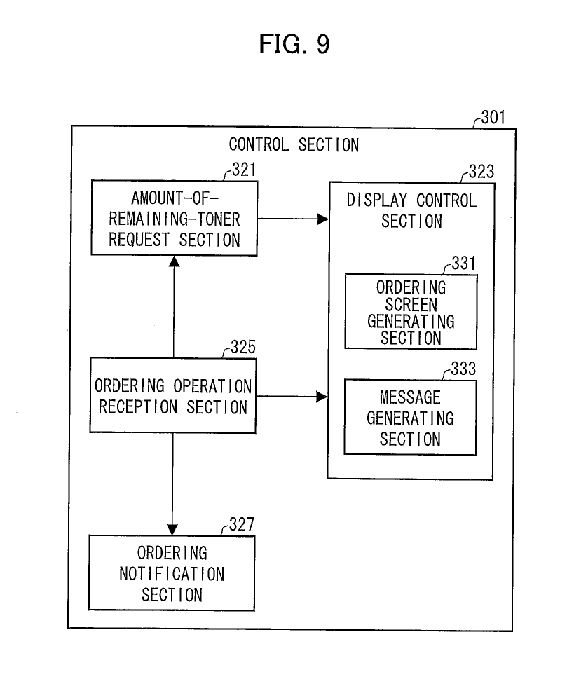

FIG. 9 is a functional block diagram showing an example of functions of the control section included in the PC. As shown in FIG. 9, the control section 301 includes an amount-of-remaining-toner request section (remaining amount request section) 321, an ordering operation reception section 325, a display control section 323, and an ordering notification section 327. The amount-of-remaining-toner request section 321, the ordering operation reception section 325, the display control section 323, and the ordering notification section 327 are formed by executing a printer driver program. Furthermore, an operating system program is installed into the PC 120, and the control section 301 executes the operating system program.

When a user presses a displayed printing button via the operation section 303 while data to be printed is displayed, the operating system receives a printing instruction and causes a printing initial screen for setting a printing condition to be displayed in a window. When the user enters a printing condition setting instruction via the operation section 303 according to the guidance of the printing initial screen displayed in the window, the operating system receives the printing condition setting instruction, and the control section 301 executes the printer driver program. Consequently, the amount-of-remaining-toner request section 321, the ordering operation reception section 325, the display control section 323, and the ordering notification section 327 are formed. Hereinafter, the window in which the printing initial screen is displayed is referred to as a first window.

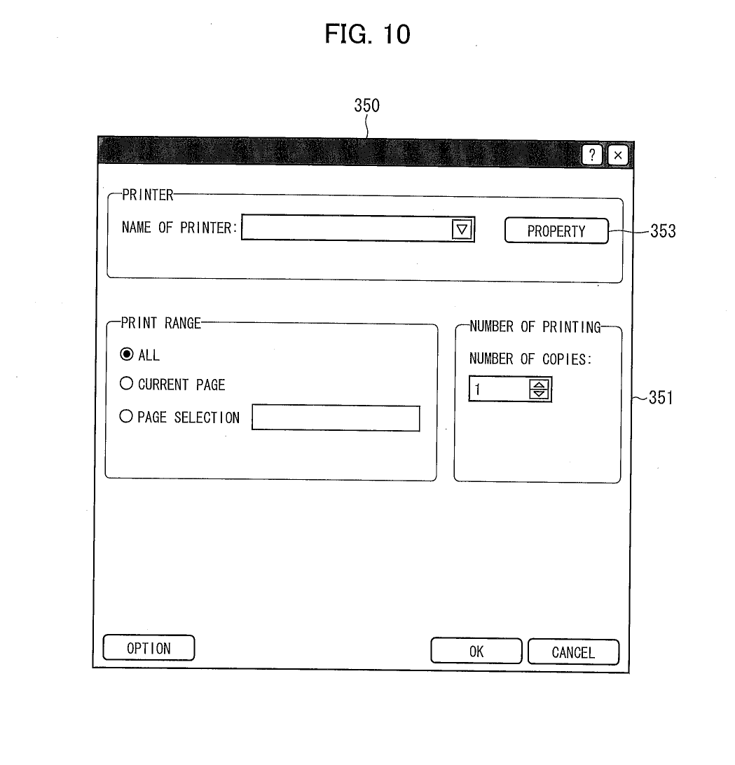

FIG. 10 is a drawing showing an example of the printing initial screen together with the first window. As shown in FIG. 10, a printing initial screen 351 shown in a first window 350 is a screen for setting printing conditions such as a printing range and the number of printing. The printing initial screen 351 includes a property button 353. The property button 353 is a button for inputting a printing condition setting instruction. When the user presses the property button 353, a printer driver of a printer displayed on a dropdown list displaying the names of printers is started and the printing setting screen is displayed.

In the present embodiment, the printer driver is designed to acquire, at start-up, amount-of-remaining-toner information from the MFP to be controlled. Accordingly, upon reception of the printing condition setting instruction from the operating system, the amount-of-remaining-toner request section 321 requests the MFP 100 to transmit the amount of remaining toner in the toner cartridge 98. Alternatively, the present embodiment may be arranged such that amount-of-remaining-toner information has been acquired in intercommunications between the PC 120 and the MFP 100 which are carried out at an appropriate time based on a communication protocol, and the started printing driver refers to the amount-of-remaining-toner information which has been acquired from the MFP 100 and stored in the PC 120.

Upon reception of the request to transmit the amount of remaining toner, the MFP 100 transmits amount-of-remaining-toner information including five amount-of-remaining-toner data respectively corresponding to the five toner cartridges 98 and the determination result. The amount-of-remaining-toner request section 321 receives the amount-of-remaining-toner information from the MFP 100 via the communication I/F section 309, and outputs the received amount-of-remaining-toner information to the display control section 323.

With reference to FIG. 9 again, the display control section 323 controls the display section 305 to display screens. Specifically, the display control section 323 causes the display section 305 to display, in a window different from the first window 350, a printing setting screen that allows more detailed setting which cannot be made in the printing initial screen 351. Hereinafter, the window in which the printing setting screen is displayed is referred to as a second window.

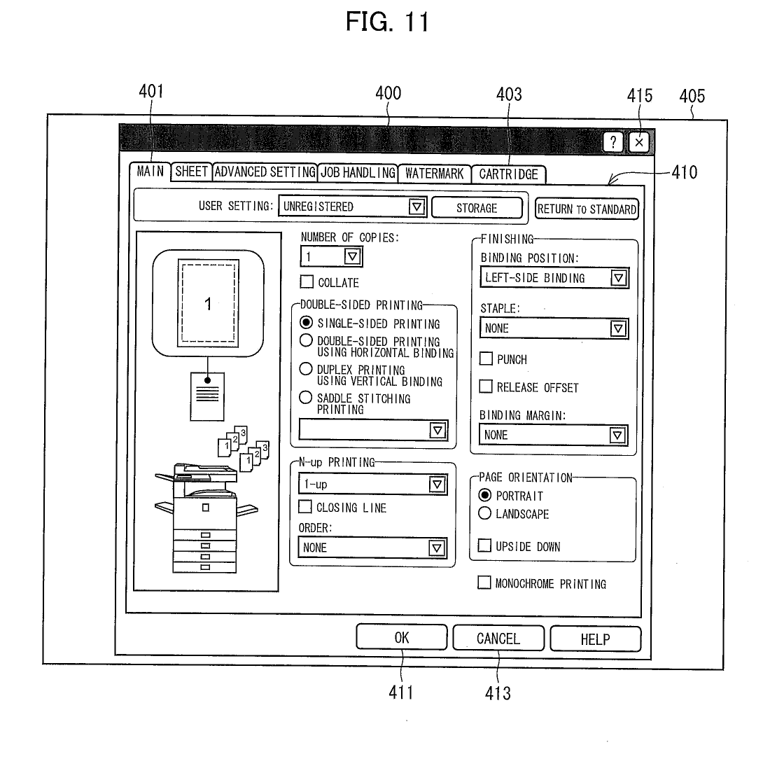

The printing setting screen includes at least a main screen and an ordering screen. The display control section 323 causes one of the main screen and the ordering screen to be displayed in the second window. As mentioned later, the main screen is a screen for setting printing conditions such as the number of printing, selection of single-side printing and double-side printing, and N-up printing in which N pages are printed in a single page (reference sign 410 in FIG. 11). As mentioned later, the ordering screen is a screen which indicates the amount of remaining toner in the toner cartridge 98 and which enables a user to purchase a toner cartridge.

In the present embodiment, in a case where the determination result included in the amount-of-remaining-toner information received from the amount-of-remaining-toner request section 321 is the first determination result indicating that there is a toner cartridge 98 whose remaining toner is in a near-shortage state, the display control section 323 causes the ordering screen to be displayed in the second window. On the other hand, in a case where the determination result is the second determination result indicating that there is no toner cartridge 98 whose remaining toner is in a near-shortage state, the display control section 323 causes the main screen to be displayed in the second window. The display control section 323 may cause the main screen and the ordering screen to display, using multiple windows, tabs corresponding to other screens which are not displayed in the second window. In this case, upon user's operation to designate a tab, the display control section 323 switches the screen to a screen corresponding to the designated tab. An explanation is made below as to an example of using multiple windows.

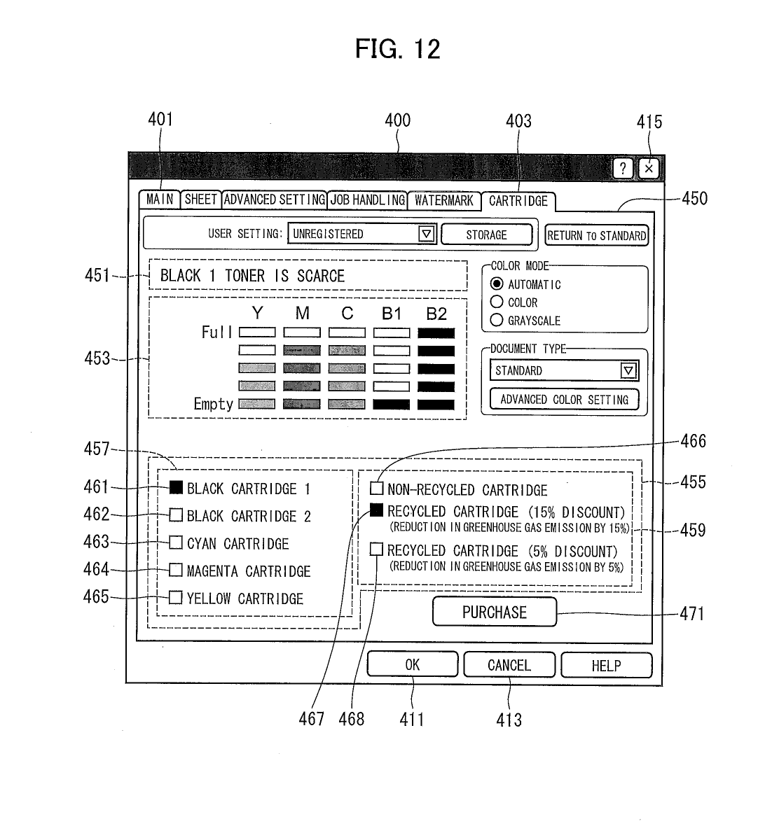

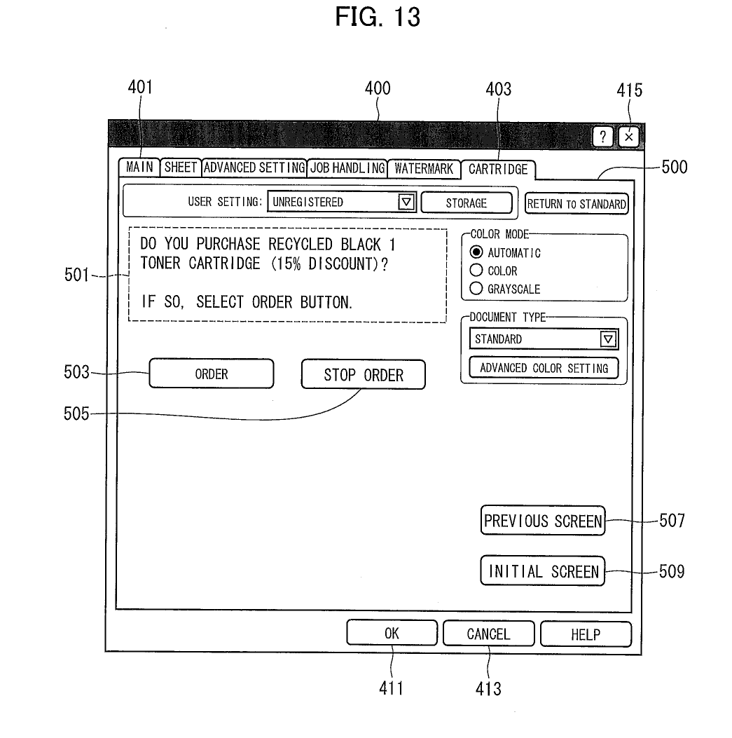

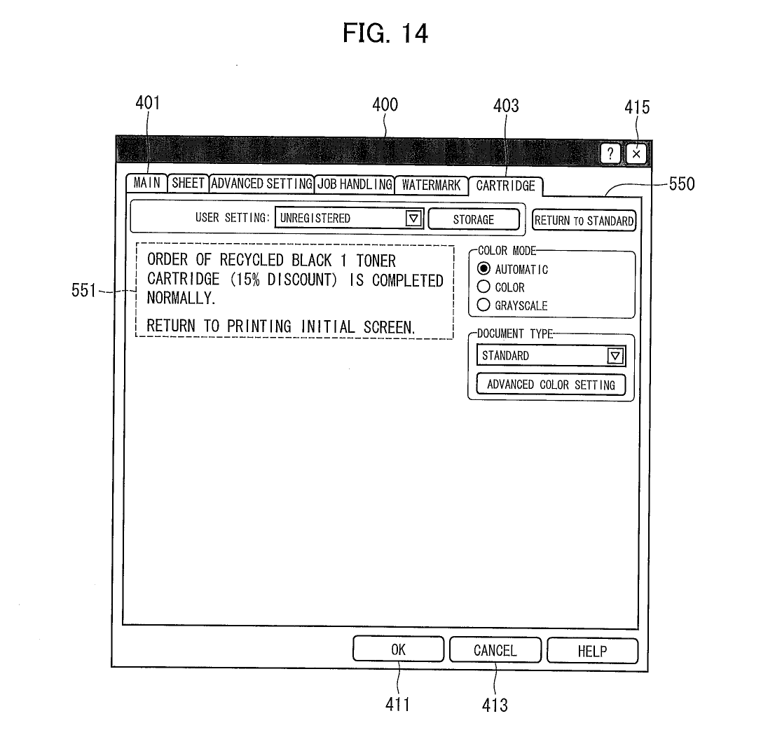

The ordering screen includes a cartridge screen (reference sign 450 in FIG. 12), an ordering confirmation screen (reference sign 500 in FIG. 13), and an ordering completion screen (reference sign 550 in FIG. 14). The cartridge screen is a screen which shows the amounts of remaining toner in the toner cartridges 98 and via which a user designates which kind of a toner cartridge the user wants to purchase. The ordering confirmation screen is a screen for confirming user's intention to settle purchase of the toner cartridge designated in the cartridge screen. When the user enters an instruction to settle the purchase, the toner cartridge designated in the cartridge screen is settled as a product to be ordered. The ordering completion screen is a screen which indicates that ordering is completed by settling the toner cartridge in the ordering confirmation screen as a product to be purchased.

The ordering operation reception section 325 receives user's operation to purchase a toner cartridge. When the user designates the kind of a toner cartridge via the operation section 303 according to the cartridge screen displayed in the second window and enters an instruction to purchase the toner cartridge, the ordering operation reception section 325 receives designation of that kind of a toner cartridge as a product to be purchased, and instructs the display control section 323 to switch screens.

When the user enters an ordering instruction via the operation section 303 according to the ordering confirmation screen displayed in the second window, the ordering operation reception section 325 receives the ordering instruction for the toner cartridge designated in the cartridge screen. Upon reception of the ordering instruction, the ordering operation reception section 325 generates an order including kind identification information of the kind of the toner cartridge designated in the cartridge screen. The ordering operation reception section 325 incorporates the generated order into an order notification instruction and outputs the order notification instruction to the ordering notification section 327. Furthermore, upon reception of the ordering instruction, the ordering operation reception section 325 instructs the display control section 323 to switch screens.

The kind identification information is information for identifying the kinds of toner cartridges. In the present embodiment, the distributor manages fifteen kinds of toner cartridges which are combinations of five kinds of toner cartridges (B1, B2, C, M, Y) and three kinds of cartridge containers. Therefore, the kind identification information is information for identifying fifteen kinds of toner cartridges.

The kind identification information includes toner cartridge identification information and container identification information. The toner cartridge identification information is information for identifying the five kinds of toner cartridges 98. The container identification information is information for identifying the three kinds of cartridge containers. Accordingly, a combination of the toner cartridge identification information and the container identification information specifies one kind.

In response to the instruction from the ordering operation reception section 325 to switch screens, the display control section 323 switches screens displayed in the window. Receiving the instruction from the ordering operation reception section 325 to switch screens while the cartridge screen is displayed in the second window, the display control section 323 switches the cartridge screen in the second window to the ordering confirmation screen. Receiving the instruction from the ordering operation reception section 325 to switch screens while the ordering confirmation screen is displayed in the second window, the display control section 323 switches the ordering confirmation screen in the second window to the ordering completion screen.

After a predetermined time has passed from display of the ordering completion screen in the second window, the display control section 323 switches the screen in the second window to the main screen.

The display control section 323 includes an ordering screen generating section 331 and a message generating section 333. The message generating section 333 generates a near-shortage message in accordance with the determination result by the MFP 100. Specifically, on condition that the determination result included in the amount-of-remaining-toner information received by the amount-of-remaining-toner request section 321 is the first determination result that indicates existence of the toner cartridge 98 whose remaining toner is in a near-shortage state, the message generating section 333 generates a near-shortage message. The near-shortage message indicates that the amount of remaining toner in the toner cartridge 98 identified by toner cartridge identification information included in the determination result from the amount-of-remaining-toner request section 321 is small. For example, the near-shortage message reads “black 1 toner is scarce” (reference sign 451 in FIG. 12). The message generating section 333 outputs the generated near-shortage message to the ordering screen generating section 331.

When the ordering operation reception section 325 receives a purchase instruction, the message generating section 333 generates an ordering confirmation message. Specifically, the message generating section 333 generates, as the ordering confirmation message, a message that confirms whether to settle the order of the toner cartridge received by the ordering operation reception section 325 via the cartridge screen. The ordering confirmation message reads, for example, “Settle purchase of recycled black 1 toner cartridge (15% off)?” (see reference sign 501 in FIG. 13). The message generating section 333 outputs the generated ordering confirmation message to the ordering screen generating section 331.

When the ordering operation reception section 325 receives the ordering instruction, the message generating section 333 generates an ordering completion message. Specifically, the message generating section 333 generates, as the ordering completion message, a message indicating that ordering is completed by settling purchase of the kind of the toner cartridge received by the ordering operation reception section 325 in the cartridge screen. The ordering completion message reads, for example, “Order of recycled black 1 toner cartridge (15% off) is completed normally” (reference sign 551 in FIG. 14). The message generating section 333 outputs the generated ordering completion message to the ordering screen generating section 331.

The ordering screen generating section 331 generates an ordering screen based on the amount-of-remaining-toner information received by the amount-of-remaining-toner request section 321 and the message generated by the message generating section 333. Specifically, the ordering screen generating section 331 generates the cartridge screen, the ordering confirmation screen, and the ordering completion screen.

In a case where the determination result of the amount-of-remaining-toner information is the second determination result indicating that there is no toner cartridge 98 whose remaining toner is in a near-shortage state, the ordering screen generating section 331 generates a cartridge screen showing amounts of remaining toner in five amount-of-remaining-toner data and toner cartridge identification information that are included in the amount-of-remaining-toner information. In a case where the determination result of the amount-of-remaining-toner information is the first determination result indicating that there is a toner cartridge 98 whose remaining toner is in a near-shortage state, the ordering screen generating section 331 generates a cartridge screen showing amounts of remaining toner in five amount-of-remaining-toner data and toner cartridge information that are included in the amount-of-remaining-toner information and the near-shortage message generated by the message generating section 333.

When the ordering operation reception section 325 receives the purchase instruction, the ordering screen generating section 331 generates an ordering confirmation screen showing the ordering confirmation message generated by the message generating section 333.

When the ordering operation reception section 325 receives the ordering instruction, the ordering screen generating section 331 generates an ordering completion screen showing the ordering completion message generated by the message generating section 333.

FIG. 11 is a first drawing showing an example of the printing setting screen together with the second window displayed by the display. Here, an explanation is made as to an example in which there is no toner cartridge 98 whose remaining shortage is in a near-shortage state. As shown in FIG. 11, a second window 400 is displayed in a display region 405 of the display, and a printing setting screen is displayed in the second window 400. In this example, since there is no toner cartridge 98 whose remaining toner is in a near-shortage state, the printing setting screen displayed in the second window 400 as a result of the user's pressing the property button 353 in the printing initial screen 350 (see FIG. 10) is a main screen 410. In the main screen 410, the user can set printing conditions such as the number of printing, selection of single-side printing and double-side printing, and N-up printing in which N pages are printed in a single page.

A plurality of tabs are displayed in the second window 400, and the user can specify one of the plurality of tabs. The plurality of tabs include at least a main tab 401 and a cartridge tab 403. The present example may be arranged such that the cartridge tab 403 is displayed on condition that the user makes user authentication by entering an authentication password via the operation section 303. The authentication password may be user identification information for identifying a user. The user identification may be set in advance.

The main tab 401 is related to a command for requesting display of the main screen 410, and the cartridge tab 403 is related to a command for requesting display of the cartridge screen. When the user designates one of the main tab 401 and the cartridge tab 403, a screen corresponding to the designated tab is displayed in the second window 400. In this example, since the main screen 410 is displayed in the second window 400, it is possible to designate the cartridge tab 403.

The second window 400 includes an OK button 411, a cancel button 413, and a close button 415. The OK button 411 is related to a command for validating conditions set in a screen displayed in the second window 400. When the user presses the OK button 411, a printing condition and a purchase condition which were designated by the user in the printing setting screen are validated and then display of the second window 400 is ceased.

The cancel button 413 and the close button 415 are related to commands for invalidating conditions set in a screen displayed in the second window. When the user presses the cancel button 413 or the close button 415, a printing condition and a purchase condition which were designated by the user in the printing setting screen are invalidated and then display of the second window 400 is ceased.

FIG. 12 is a second drawing showing an example of the printing setting screen together with the second window. Here, an explanation is made as to an example in which there is a toner cartridge 98 whose remaining shortage is in a near-shortage state. As shown in FIG. 12, a printing setting screen is displayed in the second window 400. In this example, since there is a toner cartridge 98 whose remaining toner is in a near-shortage state, the printing setting screen displayed in the second window 400 as a result of the user's pressing the property button 353 in the printing initial screen 350 is a cartridge screen 450. The cartridge screen 450 includes a message display region 451, an amount-of-remaining-toner display region 453, a toner cartridge kind display region 455, and a purchase button 471.

The amount-of-remaining-toner display region 453 is a region for displaying the amount of remaining toner with respect to each of the five toner cartridges 98. The amount-of-remaining-toner display region 453 displays five amount-of-remaining-toner data received from the MFP 100. The amount of remaining toner is indicated by five-graduated scale marks.

A first scale mark indicates that the amount of toner remaining in the toner cartridge 98 is 0-20% of the maximum amount of toner containable in the toner cartridge 98. A second scale mark indicates that the amount of toner remaining in the toner cartridge 98 is 20-40% of the maximum amount of toner containable in the toner cartridge 98. A third scale mark indicates that the amount of toner remaining in the toner cartridge 98 is 40-60% of the maximum amount of toner containable in the toner cartridge 98. A fourth scale mark indicates that the amount of toner remaining in the toner cartridge 98 is 60-80% of the maximum amount of toner containable in the toner cartridge 98. A fifth scale mark indicates that the amount of toner remaining in the toner cartridge 98 is 80-100% of the maximum amount of toner containable in the toner cartridge 98. For example, the amount of remaining toner in the B1 toner cartridge 98 is at the first scale mark, which indicates that the amount of remaining toner corresponds to 0-20% of the maximum amount, i.e. the amount of remaining toner in the B1 toner cartridge 98 is small. Consequently, a user who sees the scale mark of the amount of toner remaining in the B1 toner cartridge 98 displayed in the amount-of-remaining-toner display region 453 can visually recognize the amount of remaining toner, so that the user can easily know timing to purchase a toner cartridge. Here, the amount of remaining toner is indicated by a ratio of the amount of remaining toner to the maximum amount of toner containable in the toner cartridge 98. Alternatively, by incorporating the amount of toner in the developing device 2 into the maximum amount of toner containable in the toner cartridge 98, the amount of remaining toner may be indicated by a ratio of the amount of remaining toner to the sum of the maximum amount of toner containable in the toner cartridge 98 and the amount of toner in the developing device 2.

The message display region 451 is a region for displaying that remaining toner in the toner cartridge 98 is in a near-shortage state. In a case where the determination result from the MFP 100 is the first determination result indicating that there is a toner cartridge whose remaining amount is in a near-shortage state, the message display region 451 displays a near-shortage message indicating that the amount of remaining toner in the toner cartridge 98 identified by the toner cartridge identification information included in the first determination result is small. Here, near-shortage of the amount of remaining toner in the B1 toner cartridge 98 is indicated by a message reading “Black 1 toner is scarce”. This message allows a user to recognize which toner cartridge has remaining toner in a near-shortage state, so that the user can easily know timing to purchase a toner cartridge, and know which toner cartridge is to be purchased.

The toner cartridge kind display region 455 is a region for displaying the kinds of toner cartridges that can be purchased by the user and setting the kind of a toner cartridge to be purchased. The toner cartridge kind display region 455 includes a toner cartridge display region 457 and a cartridge container display region 459.

The toner cartridge display region 457 is a region for displaying kinds of toner cartridges which can be purchased by a user and setting the kind of a toner cartridge to be purchased. The toner cartridge display region 457 includes check boxes corresponding to toner cartridge identification information of the toner cartridges 98, respectively. In this example, the toner cartridge display region 457 includes a check box 461 for designating a B1 toner cartridge as a cartridge to be purchased, a check box 462 for designating a B2 toner cartridge as a cartridge to be purchased, a check box 463 for designating a C toner cartridge as a cartridge to be purchased, a check box 464 for designating an M toner cartridge as a cartridge to be purchased, and a check box 465 for designating a Y toner cartridge as a cartridge to be purchased. In the example in FIG. 12, the B1 toner cartridge is designated as a cartridge to be purchased.

The cartridge container display region 459 is a region for displaying kinds of cartridge containers which can be purchased by a user and setting the kind of a cartridge container to be purchased. The cartridge container display region 459 displays check boxes corresponding to container identification information of cartridge containers, respectively. In this example, the cartridge container display region 459 includes a check box 466 for designating a non-recycled cartridge container as a cartridge container to be purchased, a check box 467 for designating a first recycled cartridge container as a cartridge container to be purchased, and a check box 468 for designating a second recycled cartridge container as a cartridge container to be purchased. The check boxes 466-468 can be checked exclusively. In the example shown in FIG. 12, the first recycled cartridge container is designated as a cartridge container to be purchased.

The purchase button 471 is a button for settling the kind of the toner cartridge designated by the user as a toner cartridge to be purchased. When the user presses the purchase button 471, the kind of the toner cartridge designated in the toner cartridge display region 457 with the kind of the cartridge container designated in the cartridge container display region 459 is settled as a toner cartridge to be purchased. Thus, the kind of the toner cartridge designated as a toner cartridge to be purchased is settled as an order. In this example, when the user presses the purchase button 471, the B1 toner cartridge with the first recycled cartridge container is settled as an order. The settle of the order by the user's pressing the purchase button 471 causes an ordering confirmation screen to be displayed in the second window 400.

In the above, an explanation was made as to an example where the first recycled cartridge container is designated as a cartridge container. The present embodiment may be arranged such that when a user presses the purchase button 471 while designating the non-recycled cartridge container, there is displayed a message for urging the user to reconsider and designate again the first recycled cartridge container or the second recycled cartridge container. For example, in order to urge the user to reconsider and designate again the first recycled cartridge container or the second recycled cartridge container, there may be displayed a message reading “recycled cartridge container is lower in price and prevents global warming”.

The second window 400 includes the OK button 411, the cancel button 413, and the close button 415. When the user presses the OK button 411, the cancel button 413, or the close button 415, display of the second window 400 is ceased.

In the above example, in the case where there is a toner cartridge 98 whose remaining toner is in a near-shortage state, the cartridge screen 450 is displayed in the second window 400. Alternatively, in that case, the main screen 410 may be displayed in the second window 400 while urging a user to switch the screen to the cartridge screen 450. For example, arranging the cartridge tab 403 to blink can attracts user's attention and therefore can urge the user to press the cartridge tab 403 to switch the screen to the cartridge screen 450.

As described above, the cartridge screen 450 includes the amount-of-remaining-toner display region 453 for displaying the amounts of remaining toner in the five toner cartridges 98, respectively, the toner cartridge display region 457 for displaying kinds of toner cartridges which can be purchased by a user and setting the kind of a toner cartridge to be purchased, and the cartridge container display region 459 for displaying kinds of cartridge containers which can be purchased by a user and setting the kind of a cartridge container to be purchased. Accordingly, a user can designate the kind of a toner cartridge to be purchased in the toner cartridge display region 457 and in the cartridge container display region 459 while referring to the amount-of-remaining-toner display region 453 and confirming which toner cartridge has a small amount of remaining toner. This prevents the user from mistakenly purchasing a toner cartridge having a sufficient amount of remaining toner instead of a toner cartridge having a small amount of remaining toner. Therefore, the user can purchase a necessary toner cartridge without mistake.

FIG. 13 is a drawing showing an example of the ordering confirmation screen displayed in the second window. As shown in FIG. 13, the ordering confirmation screen 500 includes a message display region 501, an order button 503, an order stop button 505, a previous screen button 507, and an initial screen button 509.

The message display region 501 is a region for displaying a settled order. Furthermore, the message display region 501 displays a message for urging a user to determine whether the settled order shall be made or not. In this example, there is displayed a message reading “Do you purchase recycled black 1 toner cartridge (15% off)? If so, press order button”. This allows the user to reconfirm the kind of the toner cartridge to be purchased.

The order button 503 is a button for making an order. When the user presses the order button 503, the order settled in the cartridge screen 450 is made, and the ordering completion screen is displayed. The order stop button 505 is a button for cancelling an order. When the user presses the order stop button 505, the main screen 410 is displayed in the second window 400. The previous screen button 507 is a button for returning to one-previous screen. When the user presses the previous screen button 507, the cartridge screen 450 is displayed in the second window 400 again. At that time, in the cartridge screen 450, the check box for designating the kind of the toner cartridge having been settled in the order is in a checked state. Accordingly, it is unnecessary to designate again the toner cartridge having been already settled as a toner cartridge to be purchased. Consequently, when the user wants to purchase an additional toner cartridge, the user is only required to designate the toner cartridge to be purchased additionally. Therefore, operations for designating the toner cartridge by the user can be reduced. The initial screen button 509 is a button for displaying a default screen. Assume here that the main screen 410 is a default screen. When the user presses the initial screen button 509, the main screen 410 is displayed in the second window 400.

Furthermore, the second window 400 includes the OK button 411 and the cancel button 413. When the user presses the OK button 411 or the cancel button 413, display of the second window 400 is ceased.

FIG. 14 is a drawing showing an example of the ordering completion screen displayed in the second window. As shown in FIG. 14, the ordering completion screen 550 includes a message display region 551. The message display region 551 is a region for displaying that the settled order has been made. Furthermore, the message display region 551 displays a message for showing return to the printing initial screen 351. In this example, there is displayed a message reading “Order of recycled black 1 toner cartridge (15% off) has been made normally. Return to printing initial screen”. This allows the user to recognize that the kind of the toner cartridge to be purchased has been ordered.

With reference to FIG. 9 again, upon reception of the order instruction from the ordering operation reception section 325, the ordering notification section 327 notifies the server PC 101 of the order of the toner cartridge. The ordering notification section 327 transmits, to the server PC 101 via the communication I/F section 309, the order included in the order notification instruction from the ordering operation reception section 325. Consequently, the distributor managing the server PC 101 ships a toner cartridge to the user of the PC 120 in accordance with the order received by the server PC 101, so that the user of the PC 120 can purchase the kind of the toner cartridge designated in the cartridge screen 450.

The address for shipping is the PC to which the printer driver for controlling the MFP 100 has been installed, in this example, the addresses which the users of the PCs 120 and 130 have registered respectively in the server PC of the distributor in advance. In this example, the server PC may store the addresses of the users of the PCs 120 and 130 in such a manner that the addresses are related to device identification information of the PCs 120 and 130, respectively, or in such a manner that the addresses are related to user identification information of the users of the PCs 120 and 130, respectively.

In the case where the addresses of the users of the PCs 120 and 130 are stored in such a manner that the addresses are related to the user identification information of the users of the PCs 120 and 130, respectively, the name of the user is requested as user identification information in the order screen, and the name entered in response to the request is incorporated into the order. Alternatively, the address for shipping may be requested in the order screen.

As described above, when the user presses the property button 353 on the printing initial screen 351, the printing setting screen is displayed. The printing setting screen includes the cartridge screen 450 for showing information on the amounts of remaining toner. Accordingly, when setting printing conditions and purchase conditions on the printing setting screen, the user can check the amounts of remaining toner in the five toner cartridges 98, respectively, by causing the printing setting screen to display the cartridge screen 450. Furthermore, in the present embodiment, when the user presses the property button 353 on the printing initial screen 351, the main screen 410 or the cartridge screen 450 which is the order screen is displayed as the printing setting screen depending on the determination result by the MFP 100. That is, in a case where the determination result indicates that there is no toner cartridge 98 whose remaining toner is in a near-shortage state, the main screen 410 is displayed, and in a case where the determination result indicates that there is a toner cartridge 98 whose remaining toner is in a near-shortage state, the cartridge screen 450 is displayed. Consequently, when one of the five toner cartridges 98 has remaining toner in a near-shortage state, the cartridge screen 450 is displayed in preference to other screens, so that the near-shortage message allows the user to easily recognize which toner cartridge is to be purchased. Furthermore, when one of the five toner cartridges 98 has remaining toner in a near-shortage state, the user is not confused about which screen is to be displayed in order to purchase a toner cartridge. Therefore, when one of the five toner cartridges 98 has remaining toner in a near-shortage state, even a user who is not familiar with operations on the screen can easily purchase a toner cartridge to be purchased. Furthermore, since the near-shortage message urges the user to order a toner cartridge to be purchased, it is possible to avoid stock shortage of toner cartridges.

Furthermore, the cartridge screen 450 is designed to allow a user to designate the first recycled cartridge container or the second recycled cartridge container as the container of the toner cartridge to be purchased, with a message that the first and second recycled cartridge containers are lower in prices than the non-recycled cartridge container and are recycled consumable supplies with reduced CO₂ emissions in their productions. Since the recycled consumable supplies can be purchased at lower prices than the non-recycled consumable supply, it is possible to urge the user to purchase the recycled consumable supplies. This can reduce greenhouse gas emissions, thereby preventing global warming.

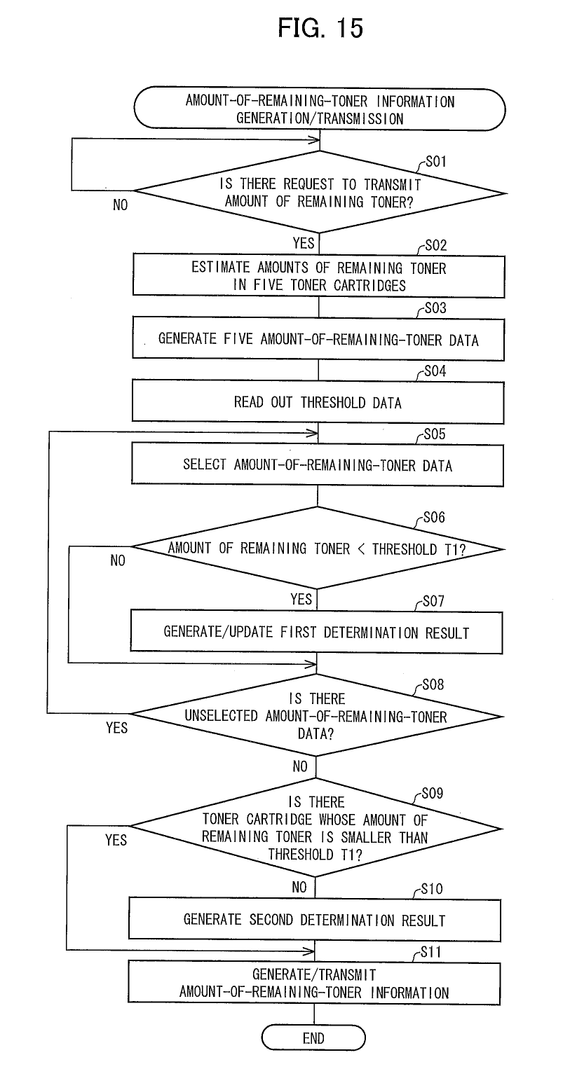

FIG. 15 is a flowchart showing an example of a flow of an amount-of-remaining-toner information generation/transmission process. The amount-of-remaining-toner information generation/transmission process is a process carried out by the control section 201 of the MFP 100 executing an amount-of-remaining-toner information generation/transmission program stored in a ROM or HDD. As shown in FIG. 15, it is determined whether there is a request to transmit the amount of remaining toner (step S01). When there is received from the PC 120 or 130 the request to transmit the amount of remaining toner (YES in step S01), the process goes to the step S02. That is, the amount-of-remaining-toner information generation/transmission process is a process carried out in response to the request from the PC 120 or 130 to transmit the amount of remaining toner.

In the step S02, the amounts of remaining toner in the five toner cartridges 98 are estimated. Specifically, the amounts of remaining toner are estimated by subtracting the accumulated amounts of consumed toner from the maximum amounts of toner containable in the toner cartridges 98, respectively. The amounts of consumed toner are calculated by a suitable combination of the first to third calculation methods mentioned above.

In the next step S03, five amount-of-remaining-toner data is generated. Specifically, with respect to each of the five toner cartridges 98, amount-of-remaining-toner data including toner cartridge identification information and the amount of remaining toner estimated in the step S02 is generated.

In the next step S04, the threshold data 241 stored in the storage section 202 is read out and the process goes to the step S05.

In the step S05, one of the five amount-of-remaining-toner data generated in the step S03 is selected and the process goes to the step S06.

In the step S06, it is determined whether the amount of remaining toner in the amount-of-remaining-toner data selected in the step S05 is smaller than the threshold T1 indicated by the threshold data 241 read out in the step S04. When the amount of remaining toner is smaller than the threshold T1, the process goes to the step S07, and when the amount of remaining toner is not smaller than the threshold T1, the process goes to the step S08.

In the step S07, there is generated the first determination result showing that there is a toner cartridge whose remaining toner is in a near shortage state. Specifically, when it is determined in the step S06 that the amount of remaining toner is smaller than the threshold T1, there is generated the first determination result including the toner cartridge identification information included in the amount-of-remaining-toner data selected in the step S05.

In the next step S08, it is determined whether there is unselected amount-of-remaining-toner data out of the five amount-of-remaining-toner data. When there is unselected amount-of-remaining-toner data, the process goes back to the step S05, and when there is no unselected amount-of-remaining-toner data, the process goes to the step S09.

The steps S05-S08 are repeated until it is determined in the step S08 that there is no unselected amount-of-remaining-toner data. Accordingly, the first determination result is updated every time when it is determined that the amount of remaining toner in the amount-of-remaining-toner data selected in the step S05 is smaller than the threshold T1. In other words, the first determination result includes toner cartridge identification information extracted from one of the five amount-of-remaining-toner data which one has remaining toner whose amount is determined as smaller than the threshold T1.

In the present embodiment, with respect to each of all the toner cartridges 98 corresponding to C, M, Y, B1, and B2, respectively, the threshold T1 is set to be 20% of the maximum amount of toner containable. Alternatively, the threshold T1 may be set individually for each of C, M, Y, B1, and B2 depending on the degree of consumption of individual colors.

In the step S09, it is determined whether there is any toner cartridge 98 whose amount of remaining toner is less than the threshold T1. When it is determined in the step S09 that there is a toner cartridge 98 whose amount of remaining toner is determined as less than the threshold T1 in the step S06, the process goes to the step S11, and when otherwise, the process goes to the step S10.

In the step S10, there is generated the second determination result indicating that there is no toner cartridge whose remaining toner is in a near-shortage amount, and the process goes to the step S11.

In the step S11, there is generated amount-of-remaining-toner information including the five amount-of-remaining-toner data generated in the step S03 and the determination result generated in the step S07 or S10. Then, the amount-of-remaining-toner information is transmitted to one of the PCs 120 and 130 which one has requested in the step S01 transmission of the amount of remaining toner, and the amount-of-remaining-toner information generation/transmission process is finished.

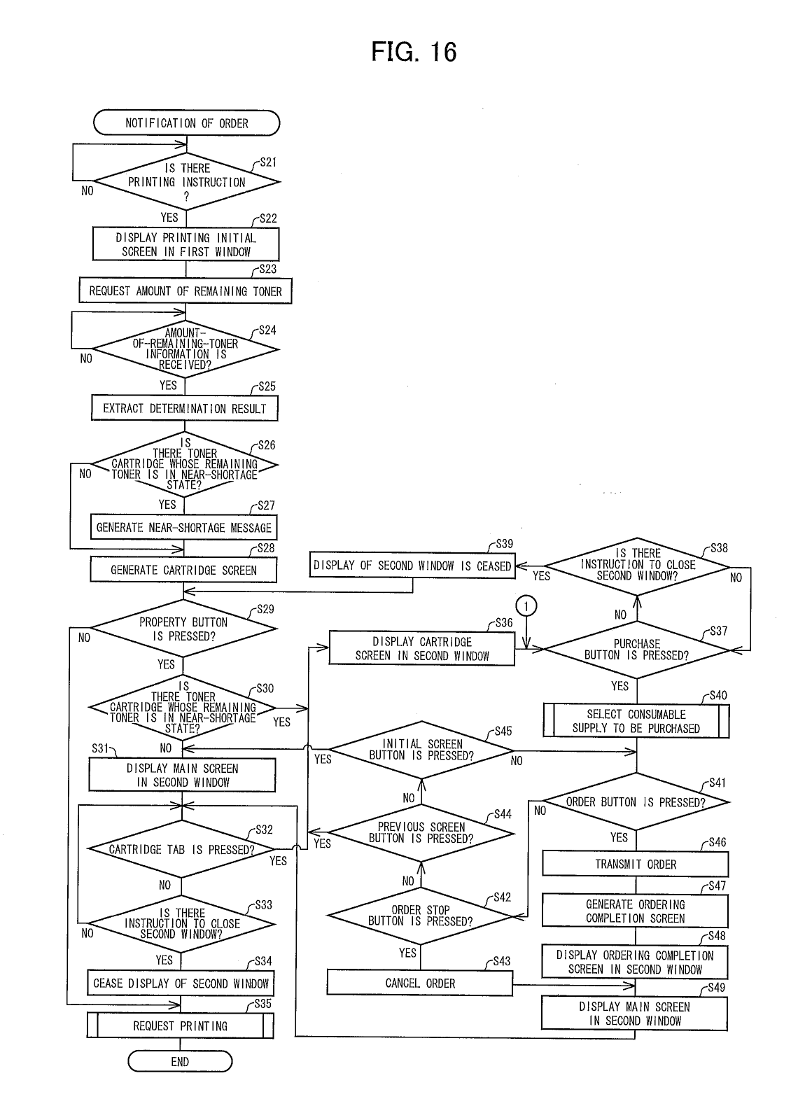

FIG. 16 is a flowchart showing an example of a flow of an ordering notification process. The ordering notification process is a process carried out by the control section 301 of the PC 120 or 130 executing an ordering notification program stored in an ROM or an HDD. As shown in FIG. 16, it is determined whether there is a printing instruction or not. When a user presses a printing button via the operation section 303 (YES in the step S21), the process goes to the step S22.

In the step S22, the printing initial screen 351 shown in FIG. 10 is displayed in the first window 350, and the process goes to the step S23.

In the step S23, the MFP 100 is requested to transmit the amount of remaining toner. Then, it is determined whether remaining-amount-of-toner information has been received from the MFP 100 (step S24). Specifically, since the MFP 100 having received the request to transmit the amount of remaining toner transmits amount-of-remaining-toner information including five amount-of-remaining-toner data corresponding to the five toner cartridges 98 respectively and the determination result, it is determined in the step S24 whether the amount-of-remaining-toner information has been received from the MFP 100 via the communication I/F section 309. When the amount-of-remaining-toner information has been received (YES in the step S24), the process goes to the step S25.

In the step S25, the determination result is extracted from the amount-of-remaining-toner information received in the step S24, and the process goes to the step S26.

In the step S26, it is determined whether there is any toner cartridge 98 whose remaining toner is in a near-shortage state. Specifically, it is determined in the step S26 whether the determination result extracted in the step S25 is the first determination result indicating that there is a toner cartridge whose remaining toner is in a near-shortage state. When the determination result extracted in the step S25 is the first determination result indicating that there is a toner cartridge whose remaining toner is in a near-shortage state, the process goes to the step S27, and when otherwise, the process goes to the step S28. Here, when the determination result extracted in the step S25 is not the first determination result indicating that there is a toner cartridge whose remaining toner is in a near-shortage state, the determination result is the second determination result indicating that there is no toner cartridge whose remaining toner is in a near-shortage state.

In the step S27, the near-shortage message is generated. The near-shortage message indicates that the amount of remaining toner in the toner cartridge 98 specified by toner cartridge identification information included in the determination result extracted in the step S25 is small. The near-shortage message reads, for example, “black 1 toner is scarce”.

In the next step S28, the cartridge screen 450 is generated. When the process proceeds from the step S27 (YES in the step S26), there is generated the cartridge screen 450 including the near-shortage message generated in the step S27 and the five amount-of-remaining-toner data received in the step S24. On the other hand, when the process proceeds from the step S26 (NO in the step S26), there is generated the cartridge screen 450 including the five amount-of-remaining-toner data received in the step S24.

In the next step S29, it is determined whether the property button 353 is pressed or not on the printing initial screen 351 displayed in the first window 350 in the step S22. When the property button 353 is pressed, the process goes to the step S30. When otherwise, the process goes to the step S35.

In the step S30, it is determined whether there is any toner cartridge 98 whose remaining toner is in a near shortage state. Specifically, it is determined in the step S30 whether the determination result extracted in the step S25 is the first determination result indicating that there is a toner cartridge whose remaining toner is in a near-shortage state. When the determination result extracted in the step S25 is the first determination result indicating that there is a toner cartridge whose remaining toner is in a near-shortage state, the process goes to the step S36, and when otherwise, the process goes to the step S31. Here, when the determination result extracted in the step S25 is not the first determination result indicating that there is a toner cartridge whose remaining toner is in a near-shortage state, the determination result is the second determination result indicating that there is no toner cartridge whose remaining toner is in a near-shortage state.

In the step S31, the main screen 410 shown in FIG. 11 is displayed in the second window 400, and the process goes to the step S32.

In the step S32, it is determined whether the cartridge tab 403 in the second window 400 displayed in the step S31 is pressed or not. When the cartridge tab 403 is pressed, the process goes to the step S36, and when otherwise, the process goes to the step S33.

When a tab other than the cartridge tab 403 out of a plurality of tabs in the second window 400 is pressed, a printing setting screen corresponding to the pressed tab is displayed in the second window 400. Accordingly, a user can set printing conditions in accordance with the printing setting screen shown in the second window 400.

In the step S33, it is determined whether there is a closing instruction to close the second window 400. When there is the closing instruction to close the second window 400, the process goes to the step S34. When otherwise, the process goes back to the step S32. The closing instruction here is an operation of pressing one of the OK button 411, the cancel button 413, and the close button 415. When the OK button 411 is pressed, the printing conditions and the purchase conditions specified on the printing setting screen displayed in the second window 400 are validated.

In the step S34, display of the second window 400 is ceased and the process goes to the step S35. The first window 350 is displayed in the display region 405.

In the step S35, a printing request process is carried out and the ordering notification process is finished. As mentioned later, the printing request process is a process for requesting the MFP 100 to print target data under the printing conditions set in accordance with the printing setting screen displayed in the second window 400 and the printing initial screen 351 displayed in the first window 350.

The process goes to the step S36 when it is determined in the step S30 that there is a toner cartridge 98 whose remaining toner is in a near-shortage state or when it is determined in the step S32 that the cartridge tab 403 is pressed. In the step S36, when the process comes from the step S30, the cartridge screen 450 generated in the step S28, which includes the near-shortage message and the five amount-of-remaining-toner data, is displayed in the second window 400. On the other hand, when the process comes from the step S32, the cartridge screen 450 including the five amount-of-remaining-toner data is displayed. The cartridge screen 450 displayed in the latter case is a screen when the five cartridges are not in a near-shortage state.

In the step S37, it is determined whether the purchase button 471 is pressed on the cartridge screen 450 displayed in the step S36. When the purchase button 471 is pressed, the process goes to the step S40. When otherwise, the process goes to the step S38.

By pressing one of a plurality of tabs in the second window 400, a printing setting screen corresponding to the pressed tab is displayed in the second window 400. Accordingly, a user can set printing conditions in accordance with the printing setting screen displayed in the second window 400.

In the step S38, it is determined whether there is a closing instruction to close the second window 400. When there is the closing instruction to close the second window 400, the process goes to the step S39. When otherwise, the process goes back to the step S37. The closing instruction here is an instruction to press one of the OK button 411, the cancel button 413, and the close button 415. Also in this case, when the OK button 411 is pressed, the printing conditions and the purchase conditions specified in the printing setting screen displayed in the second window 400 are validated.

In the step S39, display of the second window 400 is ceased, and the process goes back to the step S29. The first window 350 is displayed in the display region 405.

In the step S40, a consumable-supply-to-be-purchased designating process is carried out and the process goes to the step S41. As mentioned later, the consumable-supply-to-be-purchased designating process is a process of settling as an order the kind of the toner cartridge designated by a user on the cartridge screen 450 displayed in the second window 400 in the step S36, and letting the user confirm the settled order in the ordering confirmation screen 500 shown in FIG. 13.

In the step S41, it is determined whether the order button 503 is pressed on the ordering confirmation screen 500 displayed in the step S40. When the order button 503 is pressed, the process goes to the step S46, and when otherwise, the process goes to the step S42.

In the step S42, it is determined whether the order stop button 505 is pressed on the ordering confirmation screen 500 displayed in the step S40. When the order stop button 505 is pressed, the process goes to the step S43, and when otherwise, the process goes to the step S44.

In the step S43, the order settled in the step S40 is cancelled, and the process goes to the step S49.

In the step S44, it is determined whether the previous screen button 507 is pressed on the ordering confirmation screen 500 displayed in the step S40. When the previous screen button 507 is pressed, the process goes back to the step S36, and when otherwise, the process goes to the step S45.

In the step S45, it is determined whether the initial screen button 509 is pressed on the ordering confirmation screen 500 displayed in the step S40. When the initial screen button 509 is pressed, the process goes back to the step S31, and when otherwise, the process goes back to the step S41.

In the step S46, the order settled in the step S40 is transmitted to the server PC 101. Then, the ordering completion screen 550 including an ordering completion message is generated (step S47).

In the next step S48, the ordering completion screen 550 generated in the step S47 is displayed in the second window 400, and the process goes to the step S49.

In the step S49, after a predetermined time has passed from display of the ordering completion screen 550 in the second window 400 in the step S48, the main screen 410 is displayed in the second window 400, and the process goes back to the step S32.

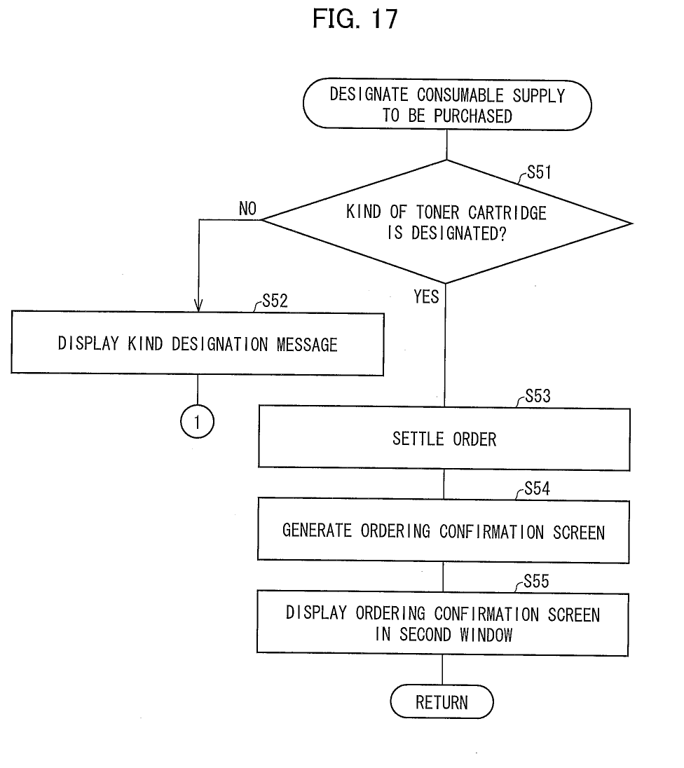

FIG. 17 is a flowchart showing an example of the consumable-supply-to-be-purchased designating process.

The consumable-supply-to-be-purchased designating process is a process carried out in the step S40 of the order notification process shown in FIG. 16. As shown in FIG. 17, it is determined whether the kind of the toner cartridge to be purchased is designated on the cartridge screen 450 displayed in the step S36 (step S51). When the kind of the toner cartridge to be purchased is designated, the process goes to the step S53, and when otherwise, the process goes to the step S52.

In the step S52, a message screen for urging a user to designate the kind of the toner cartridge to be purchased is popped up, and the process goes back to the step S37.

In the step S53, the kind of the toner cartridge designated in the step S51 is settled as an order. Specifically, an order including kind identification information on the kind of the toner cartridge specified in the step S51 is generated, and the order is settled.

In the next step S54, there is generated the ordering confirmation screen 500 including an ordering confirmation message to confirm whether the toner cartridge specified by the kind identification information included in the order settled in the step S53 is to be ordered, and the process goes to the step S55.

In the step S55, the ordering confirmation screen 500 generated in the step S54 is displayed in the second window 400, and the consumable-supply-to-be-purchased designating process is finished.

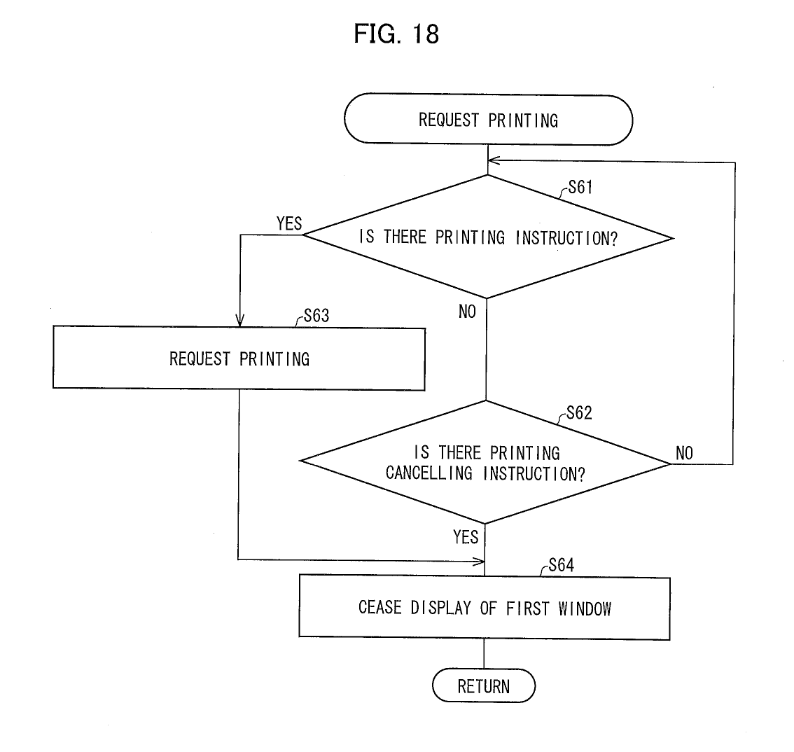

FIG. 18 is a flowchart showing an example of a flow of the printing request process. The printing request process is a process carried out in the step S35 in FIG. 16. As shown in FIG. 18, it is determined whether there is the printing instruction on the printing initial screen 351 displayed in the first window 350 (step S61). When there is the printing instruction, the process goes to the step S63, and when otherwise, the process goes to the step S62.

In the step S62, it is determined whether a printing cancelling instruction is made on the printing initial screen 351 displayed in the first window 350. When the printing cancelling instruction is made, the process goes to the step S64, and when otherwise, the process goes back to the step S61.

In the step S63, data to be printed is transmitted, together with commands indicative of printing conditions set on the printing initial screen 351 displayed in the first window 350 and on the printing setting screen displayed in the second window 400, to the MFP 100 to request formation of an image, and the process goes to the step S64.

In the step S64, display of the first window 350 is ceased, and the printing request process is finished.

In the present embodiment, the determination section 235 for determining whether remaining toner in the toner cartridge 98 is in a near-shortage state or not based on the estimated amount of remaining toner is provided in the MFP 100. Alternatively, the determination section 135 may be provided in the PCs 120 and 130. When providing the determination section 235 in the PCs 120 and 130, the determination section 235 can be realized by a printer driver of the MFP 100. In that case, the amount-of-remaining-toner information transmission section 237 transmits, to the PCs 120 and 130, amount-of-remaining-toner data including the estimated amount of remaining toner and toner cartridge identification information for identifying the toner cartridge 98.

As described above, the PC 120 in accordance with the First Embodiment is a device for controlling the MFP 100 on which the toner cartridge 98 is mounted, including the display control section 323 for causing the display section 204 to display a printing setting screen via which printing conditions corresponding to functions of the MFP 100 are set and entered into the MFP 100, the printing setting screen including an ordering screen via which an ordering instruction of a toner cartridge is entered, the ordering screen including amount-of-remaining-toner information indicative of indices of amounts of remaining toner in five toner cartridges 98 mounted on the MFP.

Accordingly, the printing setting screen via which printing conditions corresponding to functions of the MFP 100 are set and entered into the MFP 100 is displayed, and the printing setting condition includes the ordering screen via which an ordering instruction of a toner cartridge mounted on the MFP 100 is entered. Therefore, a user can purchase a toner cartridge via the ordering screen similarly with the way of setting and entering printing conditions, without being required to carry out a special operation such as selection of a printer labeled “order of consumable supply” in a dropdown list.

Furthermore, since the ordering screen is included in the printing setting screen, the ordering screen is constant without being changed independently of the user's intention like an ordering screen provided by a WEB site. Accordingly, a user who is not familiar with purchase of goods via a WEB service can easily order a desired toner cartridge without being confused at entering instructions on the screen.

Furthermore, since the ordering screen includes amount-of-remaining-toner information indicative of indices of amounts of remaining toner in toner cartridges, a user can recognize the amounts of remaining toner via the ordering screen, and when there is a toner cartridge whose remaining toner is in a near-shortage state, the user can order and purchase a toner cartridge for replacement without confusion.

As described above, the present invention allows a user who is not familiar with use of printers and information processing devices to easily purchase consumable supplies without confusion.

### Second Embodiment

In the First Embodiment, whether remaining toner in the toner cartridge 98 is in a near-shortage state or not is determined by estimating the amount of remaining toner. Furthermore, the PCs 120 and 130 are designed to show the amounts of remaining toner in the five toner cartridges 98 by ratios of the amounts of remaining toner to the maximum amounts of toner containable in the toner cartridges 98. In contrast thereto, in the Second Embodiment, whether remaining toner in the toner cartridge 98 is in a near-shortage state or not is determined by taking a record of printing and calculating the number of printable sheets with respect to each of the toner cartridges 98 based on the amount of remaining toner and the record of printing. Furthermore, in the Second Embodiment, the PCs 120 and 130 display, on the cartridge screen 450, the amounts of remaining toner in the five toner cartridges 98 by converting the amounts into the number of printable sheets.

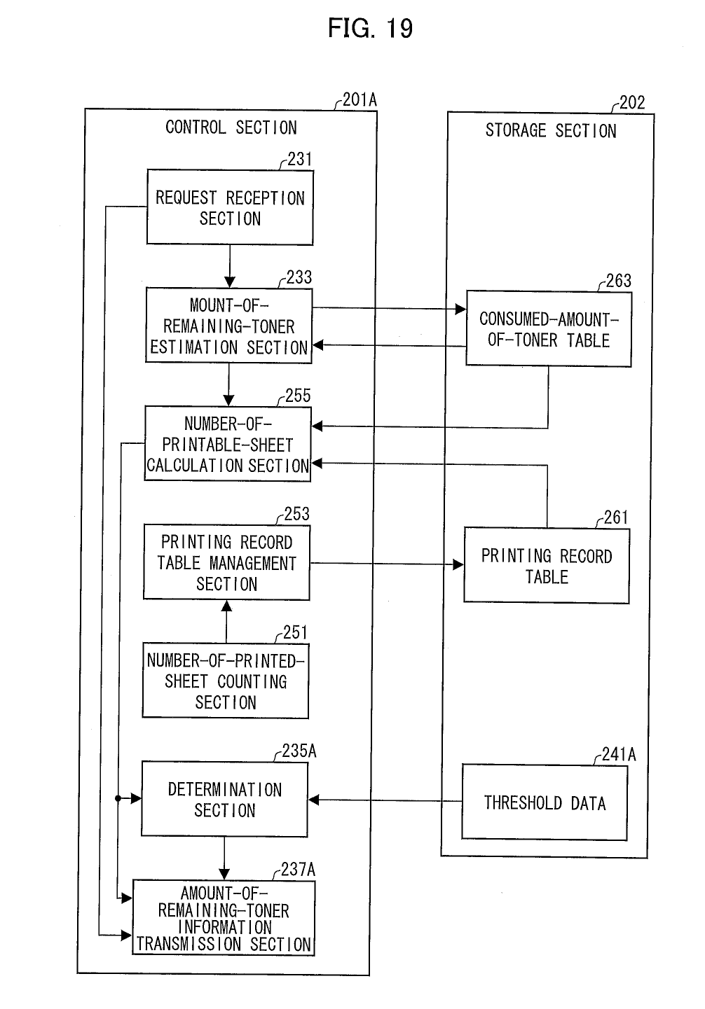

FIG. 19 is a functional block diagram showing an example of functions of a control section included in an MFP in accordance with the Second Embodiment, together with data to be stored in a storage section. A control section 201A shown in FIG. 19 is different from the control section 201 shown in FIG. 7 in that the amount-of-remaining-toner information transmission section 237 is replaced with an amount-of-remaining-toner information transmission section 237A, the determination section 235 is replaced with a determination section 235A, and a number-of-printed-sheet counting section 251, a printing record table management section 253, and a number-of-printable-sheet calculating section 255 are added. Other configurations and functions are the same as those in the control section 201 and therefore explanations thereof are omitted here.

The number-of-printed-sheet counting section 251 counts the number of sheets passing through a registration roller 13, i.e. the number of printed sheets, in accordance with on/off of a signal outputted from a sheet detection sensor 14. Specifically, every time when a sheet passes through the registration roller 13, the number of printed sheets is incremented by 1. Count of the number of printed sheets is made from the beginning of one print job to the end of the job. The number-of-printed-sheet counting section 251 counts the number of printed sheets with respect to each executed print job, and outputs the counted number of printed sheets to the printing record table management section 253. Here, the number-of-printed-sheet counting section 251 counts the number based on A4 size and single-side printing as standards. For example, in a case of double-side printing of one A3 sheet, the number of printed sheets is 4. In a case of single-side printing of five A5 sheets, the number of printed sheets is 2.5.

Every time when a print job is carried out, the printing record table management section 253 generates, with respect to each print job, a printing record including job identification information for identifying the print job, the date when the print job is carried out, and the number of sheets printed in carrying out the print job (based on A4 size and single-side printing as standards), and adds the printing record to a printing record table 261 stored in the storage section 202 and causes the record to be stored therein.

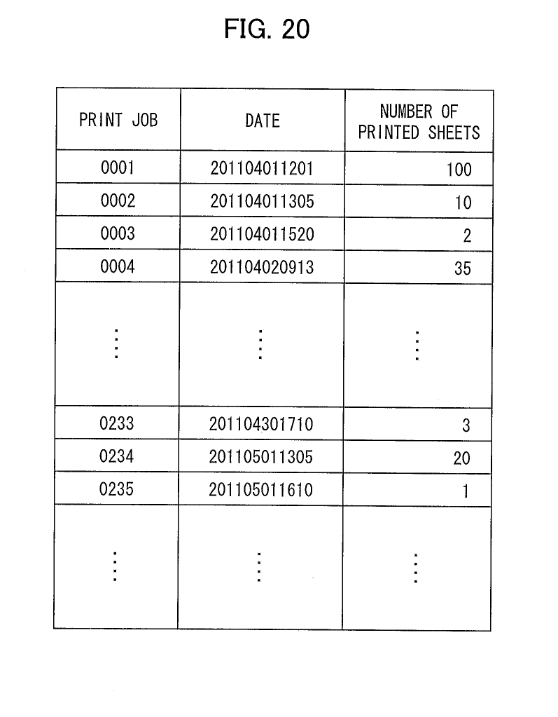

FIG. 20 is a drawing showing an example of a printing record table. As shown in FIG. 20, the printing record table includes a printing record with respect to each job. The printing record includes the item of a print job, the item of a date, and the item of the number of printed sheets. To the item of a print job is set job identification information on a print job. To the item of a date is set the date when a print job is carried out. To the item of the number of printed sheets is set the number of printed sheets counted by the number-of-printed-sheet counting section 251.

The number-of-printable-sheet calculating section 255 calculates, with respect to each of the five toner cartridges 98, the number of printable sheets corresponding to the amount of remaining toner in the toner cartridge 98 in accordance with the printing record table 261 and an amount-of-consumed-toner table 263 that are stored in the storage section 202. Specifically, the number-of-printable-sheet calculating section 255 divides the amount of remaining toner in the toner cartridge 98 estimated by an amount-of-remaining-toner estimation section 233 by the amount of consumed toner per sheet during a predetermined period to calculate the number of printable sheets. The amount of consumed toner per sheet is calculated by dividing the accumulated amount of consumed toner during the predetermined period calculated in accordance with the amount-of-consumed-toner table 263 by the accumulated number of printed sheets during the predetermined period calculated in accordance with the printing record table 261. Here, the predetermined period is one month for example. The beginning and end of a period during which the accumulated amount of consumed toner is calculated correspond to the beginning and end of a period during which the accumulated number of printed sheets is calculated. The number-of-printable-sheet calculating section 255 generates, with respect to each of the five toner cartridges 98, number-of-printable-sheet data including the calculated number of printable sheets and toner cartridge identification information, and outputs the number-of-printable-sheet data to the amount-of-remaining-toner information transmission section 237A.

The determination section 235A determines whether there is any toner cartridge 98 whose remaining toner is in a near-shortage state. The determination is made based on the five number-of-printable-sheet data generated by the number-of-printable-sheet calculating section 255 and threshold data 241A stored in a storage section 307.

The threshold data 241A is a value indicating that the number of printable sheets corresponding to the amount of remaining toner is in a near-shortage state. Here, the threshold data 241A is indicative of ten thousand sheets.

The determination section 235A compares the number of printable sheets included in each of the five number-of-printable-sheet data generated by the number-of-printable-sheet calculating section 255 with a threshold T2 indicated by the threshold data 241A, and when the number of printable sheets is less than the threshold T2 indicated by the threshold data 241A, the determination section 235A determines that the toner cartridge 98 specified by number-of-printable-sheet data which is the target of determination is in a near-shortage state of toner.

In a case where there is a toner cartridge 98 whose remaining toner is in a near-shortage state, the determination section 235A incorporates, into a first determination result indicating so, toner cartridge identification information of the toner cartridge 98 whose remaining toner is determined as being in a near-shortage state. In a case where there are a plurality of toner cartridges 98 whose remaining toner is in a near-shortage state, the determination section 235A incorporates, into a first determination result indicating so, toner cartridge identification information of the plurality of toner cartridges 98 whose remaining toner is determined as being in a near-shortage state. The determination section 235A outputs the first determination result to the amount-of-remaining-toner information transmission section 237A. In a case where there is no toner cartridge 98 whose remaining toner is in a near-shortage state, the determination section 235A outputs a second determination result indicating so to the amount-of-remaining-toner information transmission section 237A.

Upon reception of the generated five number-of-printable-sheet data from the number-of-printable-sheet calculating section 255 and reception of the determination result from the determination section 235A, the amount-of-remaining-toner information transmission section 237A transmits, via a data communication control section 206, amount-of-remaining-toner information including the received five number-of-printable sheet data and the determination result to a PC specified by device identification information included in a transmission request from a request reception section 231.

Here, an explanation is made as to a case where the PC 120 requests information on the amount of remaining toner. In the PC 120 having received amount-of-remaining-toner information, when the determination result included in the amount-of-remaining-toner information is the second determination result indicating that there is no toner cartridge 98 whose remaining toner is in a near-shortage state, the ordering screen generating section 331 generates a cartridge screen including the number of printable sheets and toner cartridge identification information that are included in each of the five number-of-printable-sheet data in the amount-of-remaining-toner information. When the determination result included in the amount-of-remaining-toner information is the first determination result indicating that there is a toner cartridge 98 whose remaining toner is in a near-shortage state, the ordering screen generating section 331 generates a cartridge screen including the number of printable sheets and toner cartridge identification information that are included in each of the five number-of-printable-sheet data in the amount-of-remaining-toner information and a near-shortage message generated by the message generating section 333. This allows a user who sees the cartridge screen to recognize the amount of remaining toner in each of the five toner cartridges 98 as the number of printable remaining sheets, so that the user can correctly know the timing to purchase a toner cartridge.

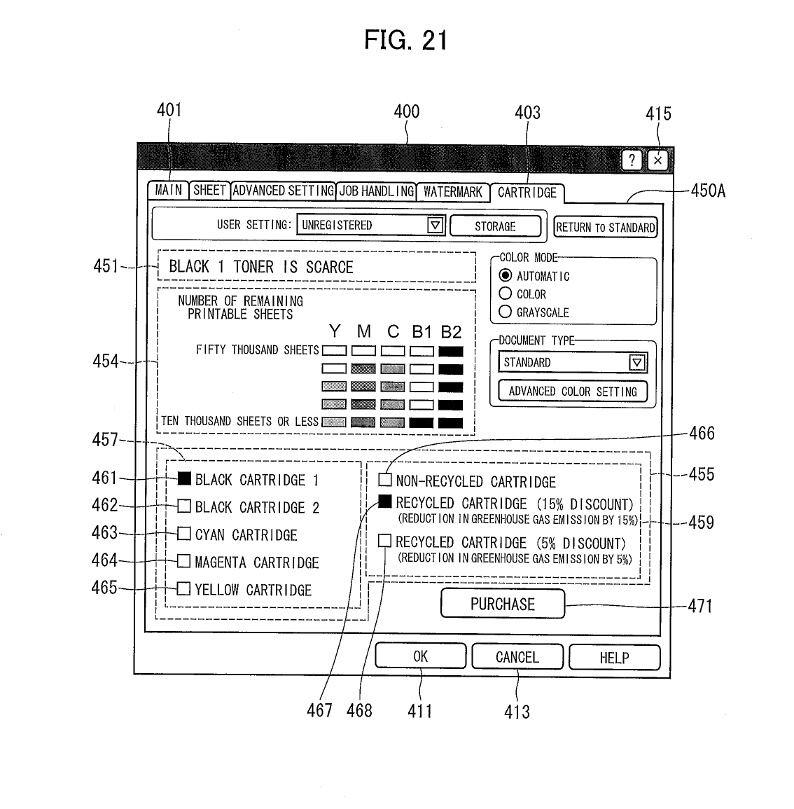

FIG. 21 is a drawing showing an example of a cartridge screen in accordance with the Second Embodiment together with the second window. A cartridge screen 450A shown in FIG. 21 is different from the cartridge screen 450 shown in FIG. 12 in that the amount-of-remaining-toner display region 453 is replaced with a number-of-printable-sheet display region 454. Here, differences from the cartridge screen 450 are explained.

The number-of-printable-sheet display region 454 is a region for displaying the number of remaining sheets printable by the amount of remaining toner with respect to each of the five toner cartridges 98. In the number-of-printable-sheet display region 454, five number-of-printable-sheet data received from the MFP 100 is displayed. The number of printable sheets is indicated by five-graduated scale marks.

A first scale mark indicates that the amount of toner remaining in the toner cartridge 98 corresponds to not more than ten thousand printable sheets. A second scale mark indicates that the amount of toner remaining in the toner cartridge 98 corresponds to ten thousand-twenty thousand printable sheets. A third scale mark indicates that the amount of toner remaining in the toner cartridge 98 corresponds to twenty thousand-thirty thousand printable sheets. A fourth scale mark indicates that the amount of toner remaining in the toner cartridge 98 corresponds to thirty thousand-forty thousand printable sheets. A fifth scale mark indicates that the amount of toner remaining in the toner cartridge 98 corresponds to forty thousand-fifty thousand printable sheets. For example, the amount of toner remaining in the B1 toner cartridge 98 is at the first scale mark, which indicates that the amount of toner remaining in the B1 toner cartridge 98 corresponds to not more than ten thousand printable sheets, i.e. a user can print ten thousand sheets at most by using toner remaining in the B1 toner cartridge 98.

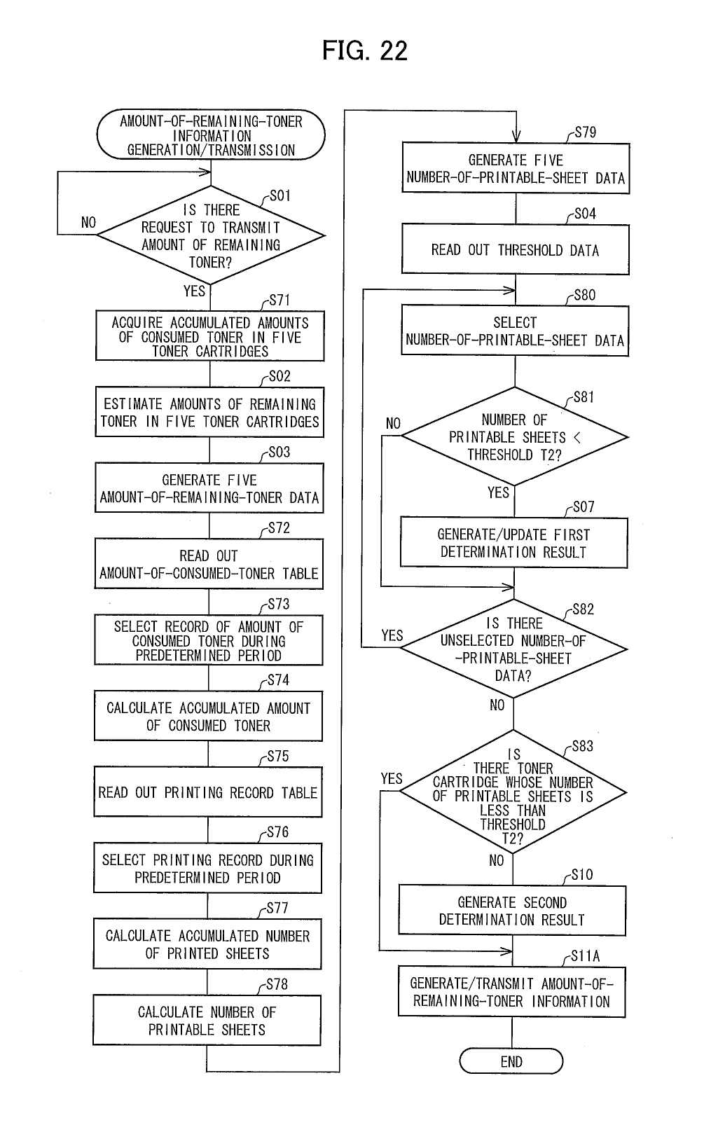

FIG. 22 is a flowchart showing an example of an amount-of-remaining-toner information generation/transmission process. The amount-of-remaining-toner information generation/transmission process shown in FIG. 22 is different from the amount-of-remaining-toner information generation/transmission process shown in FIG. 15 in that the steps S05, S06, S08, and S09 are deleted, the steps S71-S83 are added, and the step S11 is replaced with the step S11A. Other steps are the same as those in the amount-of-remaining-toner information generation/transmission process shown in FIG. 15 and therefore explanations thereof are omitted here.

In the step S71, the accumulated amount of consumed toner with respect to each of the five toner cartridges 98 is obtained from the consumed-amount-of-toner table 263 stored in the storage section 202, and the process goes to the step S72.

In the step S72, the consumed-amount-of-toner table 263 stored in the storage section 202 is read out. The record of the amount of consumed toner during a predetermined period stored in the read-out consumed-amount-of-toner table 263 is selected one by one (step S73), and the amounts of consumed toner are accumulated (step S74).

In the next step S75, the printing record table 261 stored in the storage section 202 is read out. A printing record during the predetermined period is selected one by one from the read-out printing record table 261 (step S76), and the numbers of printed sheets included in the selected printing records are accumulated (step S77).

In the next step S78, the number of printable sheets is calculated with respect to each of the five toner cartridges 98. Specifically, the number of printable sheets is calculated by dividing the amount of remaining toner estimated in the step S02 by the amount of consumed toner per sheet. The amount of consumed toner per sheet is calculated by dividing the accumulated amount of consumed toner calculated in the step S74 by the accumulated number of printed sheets calculated in the step S77.

In the next step S79, five number-of-printable-sheet data is generated. Specifically, with respect to each of the five toner cartridges 98, number-of-printable-sheet data including toner cartridge identification information and the number of printable sheets calculated in the step S78 is generated.

In the step S80, one of the five number-of-printable-sheet data generated in the step S79 is selected, and the process goes to the step S81.

In the step S81, it is determined whether the number of printable sheets included in the number-of-printable-sheet data selected in the step S80 is smaller than a threshold T2 indicated by threshold data 241A read out in the step S04. When the number of printable sheets is smaller than the threshold T2, the process goes to the step S07, and when otherwise, the process goes to the step S82.

In the step S82, it is determined whether there is unselected number-of-printable-sheet data out of the five number-of-printable-sheet data. When there is unselected number-of-printable-sheet data, the process goes back to the step S80, and when otherwise, the process goes to the step S83.

The steps S80-S82 and S07 are repeated until it is determined in the step S82 that there is no unselected number-of-printable-sheet data. Accordingly, the first determination result is updated every time when it is determined that the number of printable sheets in the number-of-printable-sheet data selected in the step S80 is smaller than the threshold T2. In other words, the first determination result includes toner cartridge identification information extracted from one of the five number-of-printable-sheet data which one includes the number of printable sheets determined as smaller than the threshold T2.

In the step S83, it is determined whether there is any toner cartridge 98 whose number of printable sheets is less than the threshold T2. When it is determined in the step S83 that there is a toner cartridge 98 whose number of printable sheets is determined as less than the threshold T2 in the step S81, the process goes to the step S11A, and when otherwise, the process goes to the step S10.

In the step S11A, amount-of-remaining-toner information including the number-of-printable-sheet data generated in the step S78 and the determination result generated in the step S07 or S10 is generated, and is transmitted to one of the PCs 120 and 130 which has requested information on the amount of remaining toner.

In the present embodiment, a printing record is taken and the number of printable sheets is calculated based on the amount of remaining toner and the printing record with respect to each toner cartridge 98, so as to determine whether remaining toner in the toner cartridge 98 is in a near-shortage state. Also in this case, the threshold T2 for determining whether remaining toner is in a near-shortage state may be set individually for each of C, M, Y, B1, and B2 depending on the frequency of use of individual colors in printing, instead of setting the threshold T2 to be the same value among C, M, Y, B1, and B2 toner cartridges 98.

For example, in the step S78 in the flowchart of FIG. 22, the number of printable sheets is calculated based on the amount of consumed toner per sheet. The degree of consumption (frequency of use) of each of C, M, Y, B1, and B2 toner can be known based on the amount of consumed toner per sheet. Accordingly, in accordance with the amounts of consumed toner per sheet of C, M, Y, B1, and B2, the control section 201 sets the threshold T2 (threshold T) to be higher for the toner cartridge 98 with a large amount of consumed toner, i.e. the toner cartridge 98 with a high consumption speed than for the toner cartridge 98 with a small amount of consumed toner, i.e. the toner cartridge 98 with a low consumption speed. This allows guiding a user to purchase consumable supplies more correctly in accordance with the amount of remaining toner.

As described above, the PCs 120 and 130 in accordance with the First and Second Embodiments are designed such that a non-recycled cartridge container can be designated on the cartridge screens 450 and 450A. Alternatively, there may be displayed cartridge screens 450 and 450A in each of which a check box for designating a non-recycled cartridge container is not provided. In this case, a user designates either a first recycled cartridge container or a second recycled cartridge container, so that the user can purchase a cartridge container which is lower in price than the non-recycled cartridge container. This contributes to prevention of global warming. Furthermore, this enables the user to be more aware of environmental conservation.

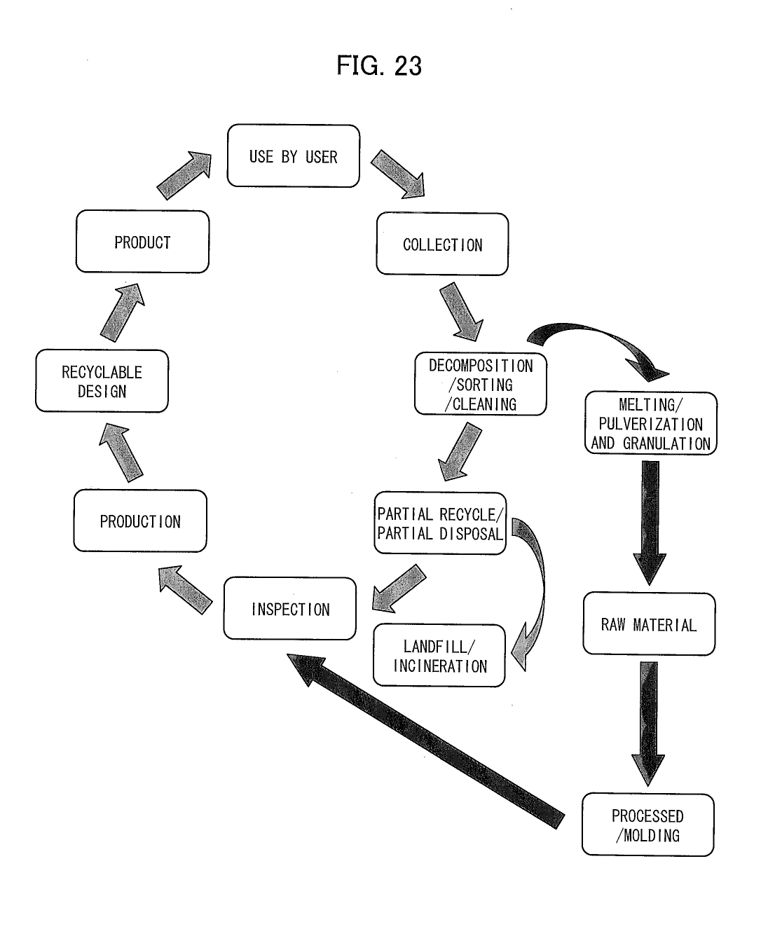

In the present embodiment, when the purchase button 471 is pressed while a non-recycled cartridge container is designated on the cartridge screens 450 and 450A, there is displayed a message for urging a user to designate again either a first recycled cartridge container or a second recycled cartridge container. Alternatively, a screen showing the flow of recycle of consumable supplies as shown in FIG. 23 may be displayed in a sub-window. This allows a user to understand the flow of recycle of toner cartridges, so that the user can recognize that purchase of the first recycled cartridge container or the second recycled cartridge container contributes to preservation of global environments. Thus, it is possible to urge the user to purchase the first recycled cartridge container or the second recycled cartridge container.

In the present embodiment, an explanation was made as to a case where a printer driver program is installed into the PCs 120 and 130. Furthermore, the printer driver program may be installed into a mobile terminal 110 so that a user can purchase a toner cartridge via the mobile terminal 110.

In the present embodiment, an explanation was made as to a case where the present invention is applied to the MFP 100 including the operation panel 50. However, application of the present invention is not limited to the MFP 100 with the above configuration as long as a device to which the present invention is applied has a display section 51 capable of displaying a message etc., and may be inkjet recording devices and other devices such as home electric appliances, household devices (electronic apparatuses, devices, or terminals that relate to images, audios, communications etc. and that are intended for use by consuming public and use in general households, or goods and standards developed and designed on the premise of such applications), commercial equipment (goods developed on the premise of applications other than general households, such as legal entities (companies, schools, public offices)) etc. In the case of inkjet recording devices, ink cartridges are used.

In the present embodiment, a user may be a general device manager that manages the MFP 100 or, more preferably, a “carbon manager” which is a special qualification for reducing CO₂ emissions. This facilitates prevalence of recycled consumable supplies with reduced greenhouse gas emissions.

Furthermore, the toner cartridge 98 in accordance with the present embodiment may be given an offset credit. This allows funding businesses capable of reducing greenhouse gas emissions, such as planting business, ocean carbon absorption business, soil carbon absorption business, carbon capture and storage business by geological storage or ocean storage, renewable energy business (e.g. hydroelectric power generation, wind power generation, marine current power generation, wave power generation, geothermal power generation, solar power generation, solar thermal power generation, tidal power generation, vibration power generation) etc., thereby contributing to prevention of global warming.

The present invention is not limited to the description of the embodiments above, but may be altered by a skilled person within the scope of the claims. An embodiment based on a proper combination of technical means disclosed in different embodiments is encompassed in the technical scope of the present invention.

Finally, the blocks of the MFP 100 and the PC 120, particularly the control section 201 and the control section 301, may be constituted by hardware logic or may be realized by software by using CPUs as follows.

That is, the MFP 100 and the PC 120 include: CPUs (central processing unit) for executing a control program for realizing each function; ROMs (read only memory) that store the program; RAMs (random access memory) that develop the program; storage devices (storage mediums) such as memories that store the program and various data; and the like. The object of the present invention can be realized in such a manner that the MFP 100 and the PC 120 are provided with a computer-readable storage medium for storing program codes (such as executable program, intermediate code program, and source program) of programs of the MFP 100 and the PC 120 which programs serve as software for realizing the functions, and a computer (alternatively, CPU or MPU) reads out and executes the program codes stored in the storage medium.

The storage medium is, for example, tapes such as a magnetic tape and a cassette tape, or discs such as magnetic discs (e.g. a Floppy Disc® and a hard disc), and optical discs (e.g. CD-ROM, MO, MD, DVD, and CD-R). Further, the storage medium may be cards such as an IC card (including a memory card) and an optical card, or semiconductor memories such as mask ROM, EPROM, EEPROM, and flash ROM.

Further, the MFP 100 may be arranged so as to be connectable to a communication network so that the program code is supplied to the MFP 100 through the communication network. The communication network is not particularly limited. Examples of the communication network include the Internet, intranet, extranet, LAN, ISDN, VAN, CATV communication network, virtual private network, telephone network, mobile communication network, and satellite communication network. Further, a transmission medium that constitutes the communication network is not particularly limited. Examples of the transmission medium include (i) wired lines such as IEEE 1394, USB, power-line carrier, cable TV lines, telephone lines, and ADSL lines and (ii) wireless connections such as IrDA and remote control using infrared ray, Bluetooth®, 802.11, HDR, mobile phone network, satellite connections, and terrestrial digital network. Note that the present invention can be also realized by the program codes in the form of a computer data signal embedded in a carrier wave, which is the program that is electrically transmitted.

As described above, the printing control device of the present invention is a printing control device for controlling a printing device equipped with a consumable supply, the printing control device including a display control section for causing a display section to display a printing setting screen via which printing conditions corresponding to functions of the printing device are set and entered into the printing device, the printing setting screen including an ordering screen via which an order of the consumable supply equipped for the printing device is entered, the ordering screen including remaining-amount-of-consumable-supply information indicative of an index of a remaining amount of the consumable supply.

With the arrangement, the display control section causes the display section to display the printing setting screen via which printing conditions corresponding to functions of the printing device are set and entered into the printing device, and the printing setting screen includes the ordering screen via which an order of the consumable supply equipped for the printing device is entered. Accordingly, a user can purchase a toner cartridge via the ordering screen similarly with the way of setting and entering printing conditions, without being required to carry out a special operation such as selection of a printer labeled “order of consumable supply” in a dropdown list.

Furthermore, since the ordering screen is included in the printing setting screen, the ordering screen is constant without being changed independently of the user's intention like an ordering screen provided by a WEB site. Accordingly, a user who is not familiar with purchase of goods via a WEB service can easily order a desired consumable supply without being confused at entering instructions on the screen.

Furthermore, since the ordering screen includes remaining-amount-of-consumable-supply information indicative of the index of the remaining amount of the consumable supply, a user can recognize the remaining amount of the consumable supply via the ordering screen, and when there is a consumable supply whose remaining amount is in a near-shortage state, the user can order and purchase a consumable supply for replacement without confusion.

As described above, the present invention enables a user who is not familiar with use of printers and information processing devices to easily purchase a consumable supply without confusion.

The printing control device of the present invention may be arranged such that when the remaining amount of the consumable supply is in a near-shortage state, the display control section causes the display section to display the printing setting screen in such a manner that the ordering screen is displayed in preference to other screens of the printing setting screen.

Normally, in many cases, a printing setting screen displays a main screen via which selection of single-side printing or double-side printing etc. is made. However, with the above arrangement, when there is a consumable supply whose remaining toner is in a near-shortage state, the ordering screen is displayed preferentially as the printing setting screen. Therefore, the preferentially displayed ordering screen enables a user to clearly recognize necessity to order a consumable supply, so that the stop of the printing device due to shortage of the consumable supply can be avoided effectively.

It is preferable to arrange the printing control device of the present invention such that the ordering screen includes at least the remaining-amount-of-consumable-supply information and kind identification information indicative of kinds of consumable supplies that can be ordered.

It is preferable to arrange the printing control device of the present invention such that the consumable supply is a toner cartridge or an ink cartridge, and the remaining-amount-of-consumable-supply information indicates a remaining amount of a coloring material in the toner cartridge or the ink cartridge.

It is preferable to arrange the printing control device of the present invention such that the consumable supply is a toner cartridge or an ink cartridge, and the remaining-amount-of-consumable-supply information indicates the number of printable sheets corresponding to a remaining amount of a coloring material in the toner cartridge or the ink cartridge.

It is preferable to arrange the printing control device of the present invention such that the consumable supply includes a recycled consumable supply A produced with smaller carbon dioxide emission than a non-recycled consumable supply and a recycled consumable supply B produced with smaller carbon dioxide emission than the recycled consumable supply A. The recycled consumable supplies A and B can contribute to prevention of global warming, unlike a new consumable supply. A manufacturer (distributor) of consumable supplies for a printing device can greatly contribute to prevention of global warming by collecting many consumable supplies having been distributed and distributing them as recycled consumable supplies. With the arrangement, a manufacturer (distributor) of printing devices can actively sell recycled consumable supplies via printing control devices sold by the manufacturer, so that the manufacturer can greatly contribute to prevention of global warming.

The printing control device of the present invention may be arranged so as to further include a remaining amount request section (remaining amount request means) for requesting the printing device to transmit the remaining-amount-of-consumable-supply information with timing when the display control section causes the display section to display the printing setting screen.

With the arrangement, a user can know the remaining amount of a consumable supply at the time when the printing setting screen is displayed, so that the user can determine more correctly whether to purchase a consumable supply or not.

The printing device of the present invention is a printing device which is controlled by a printing control device and for which a toner cartridge or an ink cartridge is equipped as a consumable supply, including: a remaining-amount-of-consumable-supply estimation section (remaining-amount-of-consumable-supply estimation means) for estimating a remaining amount of the consumable supply equipped for the printing device; a determination section for comparing the remaining amount of the consumable supply estimated by the remaining-amount-of-consumable-supply estimation section with a threshold and when the remaining amount is less than the threshold, determining that the remaining amount is in a near-shortage state; and a remaining-amount-of-consumable-supply information transmission section (remaining-amount-of-consumable-supply information transmission means) for transmitting remaining-amount-of-consumable-supply information including a result of determination by the determination section to the printing control device.

With the arrangement, the remaining-amount-of-consumable-supply estimation section estimates the remaining amount of the consumable supply equipped for the printing device, the determination section compares the estimated remaining amount of the consumable supply with a threshold and when the remaining amount is less than the threshold, determines that the remaining amount is in a near-shortage state, and the remaining-amount-of-consumable-supply information transmission section transmits remaining-amount-of-consumable-supply information including a result of determination by the determination section to the printing control device. Therefore, the printing device of the present invention can operate in combination with the printing control device of the present invention.

The printing device of the present invention may be arranged such that the remaining-amount-of-consumable-supply information transmitted by the remaining-amount-of-consumable-supply information transmission section includes the remaining amount of the consumable supply estimated by the remaining-amount-of-consumable-supply estimation section.

With the arrangement, a user of the printing control device can know not only the result of determining whether the remaining amount of a consumable supply is in a near-shortage state or not but also the actual remaining amount, so that the user can more clearly recognize necessity to order a consumable supply.

The printing device of the present invention may be arranged so as to further include: a number-of-printed-sheet counting section (number-of-printed-sheet counting means) for counting the number of printed sheets when a print job is carried out; and a printing record table management section (printing record table management means) for managing a printing record table in which the number of printed sheets counted by the number-of-printed-sheet counting section is related to a date when the print job is carried out.

With the arrangement, the printing record table management section can take a record of the date and the number of consumed sheets when the print job is carried out. When the number of sheets is that of double-side printing, the number is converted into that of single-side printing.

In this case, it is preferable to arrange the printing device of the present invention such that the remaining-amount-of-consumable-supply estimation section includes a consumed-amount-of-coloring-material calculation section for calculating an amount of a coloring material consumed in the consumable supply equipped for the printing device as a consumed amount of the coloring material, the printing device further includes a storage section for storing a consumed-amount-of-coloring-material table in which the consumed amount of the coloring material calculated by the consumed-amount-of-coloring-material calculation section (amount-of-remaining-toner estimation section) is related to a date, and a number-of-printable-sheet calculation section (number-of-printable-sheet calculation means) for calculating the number of remaining printable sheets, the number-of-printable-sheet calculation section calculates the number of printed sheets corresponding to the remaining amount of the consumable supply equipped for the printing device as the number of printable sheets, in accordance with the printing record table and the consumed-amount-of-coloring-material table, and the remaining-amount-of-consumable-supply information transmitted by the remaining-amount-of-consumable-supply information transmission section includes the number of printable sheets calculated by the number-of-printable-sheet calculation section.

With the arrangement, the consumed-amount-of-coloring-material calculation section calculates an amount of a coloring material consumed in the consumable supply equipped for the printing device as a consumed amount of the coloring material, the number-of-printable-sheet calculation section calculates the number of printed sheets corresponding to the remaining amount of the consumable supply equipped for the printing device as the number of printable sheets, in accordance with the consumed-amount-of-coloring-material table in which the calculated consumed amount of the coloring material is related to a date and the printing record table, and the remaining-amount-of-consumable-supply information transmitted by the remaining-amount-of-consumable-supply information transmission section includes the calculated number of printable sheets. Consequently, the remaining-amount-of-consumable-supply information can reflect the record of the consumed amount of the coloring material per day. Therefore, by checking the remaining-amount-of-consumable-supply information, a user of the printing control device can know, as the number of printable sheets, the remaining amount of the coloring material according to frequency in use.

The printing device of the present invention may be arranged so as to further include a threshold setting section for setting, in accordance with a consumption record of the consumable supply, the threshold used in determination by the determination section.

With the arrangement, it is possible to determine whether the remaining amount of the consumable supply is in a near-shortage state or not in consideration of frequency in use of the consumable supply.

The printing control system of the present invention is a printing control system, including: a printing device equipped with a consumable supply; and a printing control device for controlling the printing device, the printing device including: a remaining-amount-of-consumable-supply estimation section for estimating a remaining amount of the consumable supply equipped for the printing device; a determination section for comparing the remaining amount of the consumable supply estimated by the remaining-amount-of-consumable-supply estimation section with a threshold and when the remaining amount is less than the threshold, determining that the remaining amount is in a near-shortage state; and a remaining-amount-of-consumable-supply information transmission section for transmitting remaining-amount-of-consumable-supply information including a result of determination by the determination section to the printing control device, and the printing control device including a display control section for causing a display section to display a printing setting screen via which printing conditions corresponding to functions of the printing device are set and entered into the printing device, the printing setting screen including an ordering screen via which an order of the consumable supply is entered, the ordering screen including the remaining-amount-of-consumable-supply information transmitted from the printing device.

With the arrangement, it is possible to provide a printing control system that enables a user who is not familiar with use of printers and information processing devices to easily purchase a consumable supply without confusion, as already explained with respect to the printing control device of the present invention.

The printing control method of the present invention is a printing control method, carried out by a printing control device for controlling a printing device equipped with a consumable supply, the printing control method including the step of causing a display section of the printing control device to display a printing setting screen via which printing conditions corresponding to functions of the printing device are set and entered into the printing device, the printing setting screen including an ordering screen via which an order of the consumable supply equipped for the printing device is entered, the ordering screen including remaining-amount-of-consumable-supply information indicative of an index of a remaining amount of the consumable supply.

With the arrangement, it is possible to provide a printing control method that enables a user who is not familiar with use of printers and information processing devices to easily purchase a consumable supply without confusion, as already explained with respect to the printing control device of the present invention.

The printing control system of the present invention further includes a threshold setting section for setting, in accordance with a consumption record of the consumable supply, the threshold used in determination by the determination section.

### REFERENCE SIGNS LIST

1 Consumable supply ordering system (printing control system)
13 Registration roller
14 Sheet detection sensor
100 MFP (printing device)
101 Server PC
119 Toner density sensor
120, 130 PC (printing control device)
212 Cartridge motor
231 Request reception section
233 Amount-of-remaining-toner estimation section (remaining-amount-of-consumable-supply estimation section, consumed-amount-of-coloring-material calculation section)
235, 235A Determination section
237, 237A Amount-of-remaining-toner information transmission section (remaining-amount-of-consumable-supply information transmission section)
241, 241A Threshold data
251 Number-of-printed-sheet counting section
253 Printing record table management section
255 Number-of-printable-sheet calculation section
261 Printing record table
263 Consumed-amount-of-toner table (consumed-amount-of-coloring-material table)
321 Amount-of-remaining-toner request section (remaining-amount request section)
323 Display control section
325 Ordering operation reception section
327 Ordering notification section
331 Ordering screen generating screen
333 message generating screen
351 Printing initial screen
403 Cartridge tab
450, 450A Cartridge screen
500 Ordering confirmation screen
550 Ordering completion screen

1. A printing control device for controlling a printing device equipped with a consumable supply,
the printing control device comprising a display control section for causing a display section to display a printing setting screen via which printing conditions corresponding to functions of the printing device are set and entered into the printing device,
the printing setting screen including an ordering screen via which an order of the consumable supply equipped for the printing device is entered, the ordering screen including remaining-amount-of-consumable-supply information indicative of an index of a remaining amount of the consumable supply.

2. The printing control device as set forth in claim 1, wherein when the remaining amount of the consumable supply is in a near-shortage state, the display control section causes the display section to display the printing setting screen in such a manner that the ordering screen is displayed in preference to other screens of the printing setting screen.

3. The printing control device as set forth in claim 1, wherein the ordering screen includes at least the remaining-amount-of-consumable-supply information and kind identification information indicative of kinds of consumable supplies that can be ordered.

4. The printing control device as set forth in claim 1, wherein
the consumable supply is a toner cartridge or an ink cartridge, and
the remaining-amount-of-consumable-supply information indicates a remaining amount of a coloring material in the toner cartridge or the ink cartridge.

5. The printing control device as set forth in claim 1, wherein
the consumable supply is a toner cartridge or an ink cartridge, and
the remaining-amount-of-consumable-supply information indicates the number of printable sheets corresponding to a remaining amount of a coloring material in the toner cartridge or the ink cartridge.

6. The printing control device as set forth in claim 1, wherein the consumable supply includes a recycled consumable supply A produced with smaller carbon dioxide emission than a non-recycled consumable supply and a recycled consumable supply B produced with smaller carbon dioxide emission than the recycled consumable supply A.

7. The printing control device as set forth in claim 1, further comprising a remaining amount request section for requesting the printing device to transmit the remaining-amount-of-consumable-supply information with timing when the display control section causes the display section to display the printing setting screen.

8. A printing device which is controlled by a printing control device and for which a toner cartridge or an ink cartridge is equipped as a consumable supply, comprising:
a remaining-amount-of-consumable-supply estimation section for estimating a remaining amount of the consumable supply equipped for the printing device;
a determination section for comparing the remaining amount of the consumable supply estimated by the remaining-amount-of-consumable-supply estimation section with a threshold and when the remaining amount is less than the threshold, determining that the remaining amount is in a near-shortage state; and
a remaining-amount-of-consumable-supply information transmission section for transmitting remaining-amount-of-consumable-supply information including a result of determination by the determination section to the printing control device.

9. The printing device as set forth in claim 8, wherein the remaining-amount-of-consumable-supply information transmitted by the remaining-amount-of-consumable-supply information transmission section includes the remaining amount of the consumable supply estimated by the remaining-amount-of-consumable-supply estimation section.

10. The printing device as set forth in claim 8, further comprising:
a number-of-printed-sheet counting section for counting the number of printed sheets when a print job is carried out; and
a printing record table management section for managing a printing record table in which the number of printed sheets counted by the number-of-printed-sheet counting section is related to a date when the print job is carried out.

11. The printing device as set forth in claim 10, wherein
the remaining-amount-of-consumable-supply estimation section includes a consumed-amount-of-coloring-material calculation section for calculating an amount of a coloring material consumed in the consumable supply equipped for the printing device as a consumed amount of the coloring material,
the printing device further includes
a storage section for storing a consumed-amount-of-coloring-material table in which the consumed amount of the coloring material calculated by the consumed-amount-of-coloring-material calculation section is related to a date, and
a number-of-printable-sheet calculation section for calculating the number of remaining printable sheets,
the number-of-printable-sheet calculation section calculates the number of printed sheets corresponding to the remaining amount of the consumable supply equipped for the printing device as the number of printable sheets, in accordance with the record table and the consumed-amount-of-coloring-material table, and
the remaining-amount-of-consumable-supply information transmitted by the remaining-amount-of-consumable-supply information transmission section includes the number of printable sheets calculated by the number-of-printable-sheet calculation section.

12. The printing device as set forth in claim 8, further comprising a threshold setting section for setting, in accordance with a consumption record of the consumable supply, the threshold used in determination by the determination section.

13. A printing control system, comprising: a printing device equipped with a consumable supply; and a printing control device for controlling the printing device,
the printing device including:
a remaining-amount-of-consumable-supply estimation section for estimating a remaining amount of the consumable supply equipped for the printing device;
a determination section for comparing the remaining amount of the consumable supply estimated by the remaining-amount-of-consumable-supply estimation section with a threshold and when the remaining amount is less than the threshold, determining that the remaining amount is in a near-shortage state; and
a remaining-amount-of-consumable-supply information transmission section for transmitting remaining-amount-of-consumable-supply information including a result of determination by the determination section to the printing control device, and
the printing control device including a display control section for causing a display section to display a printing setting screen via which printing conditions corresponding to functions of the printing device are set and entered into the printing device, the printing setting screen including an ordering screen via which an order of the consumable supply is entered, the ordering screen including the remaining-amount-of-consumable-supply information transmitted from the printing device.

14. A printing control system, comprising: a printing device equipped with a consumable supply; and a printing control device for controlling the printing device,
the printing device including:
a remaining-amount-of-consumable-supply estimation section for estimating a remaining amount of the consumable supply equipped for the printing device and generating remaining-amount-of-consumable-supply information; and
a remaining-amount-of-consumable-supply information transmission section for transmitting the remaining-amount-of-consumable-supply information generated by the remaining-amount-of-consumable-supply estimation section to the printing control device, and
the printing control device including:
a determination section for comparing the remaining amount of the consumable supply included in the remaining-amount-of-consumable-supply information transmitted by the remaining-amount-of-consumable-supply information transmission section with a threshold and when the remaining amount is less than the threshold, determining that the remaining amount is in a near-shortage state; and
a display control section for causing a display section to display a printing setting screen via which printing conditions corresponding to functions of the printing device are set and entered into the printing device,
the printing setting screen including an ordering screen via which an order of the consumable supply is entered, the ordering screen including the remaining-amount-of-consumable-supply information including a result of determination by the determination section.

15. The printing control system as set forth in claim 13, further comprising a threshold setting section for setting, in accordance with a consumption record of the consumable supply, the threshold used in determination by the determination section.

16. The printing control system as set forth in claim 14, further comprising a threshold setting section for setting, in accordance with a consumption record of the consumable supply, the threshold used in determination by the determination section.

17. A printing control method, carried out by a printing control device for controlling a printing device equipped with a consumable supply,
the printing control method comprising the step of causing a display section of the printing control device to display a printing setting screen via which printing conditions corresponding to functions of the printing device are set and entered into the printing device,
the printing setting screen including an ordering screen via which an order of the consumable supply equipped for the printing device is entered, the ordering screen including remaining-amount-of-consumable-supply information indicative of an index of a remaining amount of the consumable supply.
